(19) United States
(12) Patent Application Publication
(10) Pub. No.: US 2005/0219245 A1
(43) Pub. Date: Oct. 6, 2005

(54) Method and system for distinguishing surfaces in 3D data sets (''dividing voxels'')

(75) Inventor: Chen Tao, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a., Milano (IT)

(21) Appl. No.: 10/998,379

(22) Filed: Nov. 29, 2004

Related U.S. Application Data
(60) Provisional application No. 60/525,821, filed on Nov. 28, 2003.
(60) Provisional application No. 60/631,273, filed on Nov. 26, 2004.

(51) Int. Cl. G06T 15/30; G06T 17/20; G06T 17/00

(52) U.S. Cl. 345/424

(57) ABSTRACT

A system and method for creating a surface for an arbitrary segment of a three-dimensional data set are presented. In exemplary embodiments according to the present invention the method includes initially identifying a set of surface voxels of the segment. For each voxel in the set information as to which of its neighbors are inside voxels can be obtained, and the results can be utilized to determine the location and direction of a polygonal surface dividing the voxel. The surface can then be obtained by connecting all of the polygonal surfaces. In exemplary embodiments according to the present invention the polygonal surfaces can comprise triangles. In exemplary embodiments according to the present invention the surface can be displayed in either a wireframe mode or a solid mode. In exemplary embodiments according to the present invention mesh reduction can be implemented to reduce the number of polygons in the final surface. In exemplary embodiments of the present invention the volume bounded by the mesh surface can be calculated. Additionally, if the mesh surface generated is not a closed surface, as when, for example, the segmented object has been cropped prior to generation of the mesh surface, any “holes” within it can be closed by a mesh and then the volume can be calculated.

### CROSS REFERNCE TO RELATED APPLICATIONS

This application claims the benefit of U.S. Provisional Patent Application Ser. No. 60/525,821 filed on Nov. 28, 2003, and of U.S. Provisional Patent Application Ser. No. ______, entitled METHOD AND SYSTEM FOR DISTINGUISHING SURFACES IN 3D DATA SETS (“DIVIDING VOXELS”), Chen Tao, inventor, filed on Nov. 26, 2004. Applicant reserves the right to amend this application to provide the serial number of this latter provisional patent application.

### TECHNICAL FIELD

The present invention relates to the analysis and display of three-dimensional (“3D”) data sets, and more particularly to the creation of surfaces encompassing an arbitrary segment of a 3D data set.

### BACKGROUND OF THE INVENTION

A volume bitmap consists of a rectangular three-dimensional grid of voxel values, which are numbers typically estimating one or more physical properties (at corresponding points in physical space) of a specimen, such as a region of a patient or an industrial product whose internal composition is of interest. These numbers may represent the value of a given property at each grid point, or an average value of the given property over some region near it which is abstracted as a volume element or voxel which is the set of points which are nearest to that grid point. Generally, when a voxel value represents an average over a given volumetric region, the actual region whose properties influence the voxel value for a particular grid point is more complex than merely the set of nearest points to it, but this abstraction is often utilized as a convenient approximation. Where the spacing of a 3D grid is equal along each of its three rectangular axes, the voxel around each grid point is a cube of unit volume with the grid point at its center; as a result the term “cube” is often used synonymously with “voxel,” as shall be done herein.

A rectangular region of space with a grid step along each edge and a grid point at each corner is also cubical in this situation, and is in this sense used in the conventional Marching Cubes algorithm. Cube in such sense shall not be used herein. We shall refer to the value in a voxel, as produced by a physical measurement system, or at a corresponding grid point, without asserting that these are true point values of the physical property. It is sometimes convenient, however, to approximate the truth by assuming this assertion. It is also useful to distinguish between a general point (x, y, z) in the space occupied by the grid, and a grid point (i, j, k) where i, j and k are integer counts of grid steps. The coordinates of (x, y, z) are measured in the same grid-step units (by which the voxels automatically become cubical), but are permitted non-integer values.

Different modalities such as, for example, Computerized Tomography (CT), Magnetic Resonance (MR), ultrasound (US), Positron Emission Tomography (PET), and seismography, etc., produce such bitmaps, estimating different properties such as opacity to X-rays or vibration waves, emission of radioactive particles, or coupling of hydrogen nuclei to their molecular surroundings. Equally, the numbers may represent the result of computing at grid points (i,j,k) a function ƒ (x,y,z) of three-dimensional position, representing a quantity of abstract interest or associating a number with any triple of values for x, y and z, whether these refer to spatial position or to quantities such as, for example, response time or return on investment. A voxel value consisting of a single number is scalar. Where a voxel value consisting of more than one number is associated with each grid point, by analogy with color models, a scan may be called spectrographic, whether or not the physics of the scanned property involve intensity of emission or reflection at a mixture of wavelengths. Spectrographic data may be associated with visible colors for display by assigning intensities of red, green and blue to the different numbers stored for an element, but with scalar scans a color may also be assigned at each element by such rules as “red if the value is greater than 42, transparent otherwise”. If the physics of the scan is such that being above this threshold value at an element correlates—with whatever degree of confidence—with the specimen being cancerous or oil-bearing or otherwise of interest at the corresponding point in the scanned object, the user looking at the display of red locations learns something about the physical layout of the tumor, oil reserve or other component of the scanned object. More complex tests may be used for color decisions, such as lying between a specified pair of values, having a value significantly above the average for nearby elements, and so on, and with spectrographic data the rules may be more complex still, involving all the components. In many such cases, however, the end result is a binary decision that the material at a physical point probably does, or probably does not, have a particular property of interest to the user.

Where the display uses a color rule like the examples above, the user perceives an object (such as a tumor), but the representation of the red locations as a collectivity occurs only in the user's perception; the computer has no explicit representation of the set of locations belonging to the object. Indeed, with a rule giving a continuous color range, as opposed to a binary distinction like ‘red versus transparent’ above, the perceived red object may not have a sharp definition: as in fuzzy logic, locations may be more or less in the set. This is a good match for human cognition, but for many purposes (such as computing the volume of a tumor) there must be a sharp, computable decision procedure for which elements are to be included in the object, and which are not. Such a procedure, with one or more segments (subsets of elements) to be distinguished from the elements of the full scan, is called segmentation of a volume image, and has a large research literature. Segmentation methods are well known, and it is assumed herein that some segmentation is used in order to label elements of the 3D data set as being inside or outside a particular class of interest. The set of inside elements is referred to herein as a segment. Depending upon the application involved, it may correspond to, for example, a skull, an oil reservoir, a cavity in a manufactured object, etc., depending upon the origin of the data and the scan modality.

A mere list of the elements in a segment is not necessarily the most useful representation of it. For example, counting elements generally gives a less accurate volume estimate than does estimating the position of a boundary surface, and computing the volume it contains. FIG. 1 illustrates a corresponding contrast of estimates in two dimensions. The circle 101 encloses an area equal to fifty squares, but surrounds only forty-five of the unit-spaced ‘inside’ sampling elements 102 that it separates from the ‘outside’ elements 103. A better estimate can come from calculating the area inside an interpolated boundary curve, in this case circle 101.

An explicit boundary surface has a great variety of other uses. For example, if one wishes to compute how far an outside point is from the object, or how deep an inside point lies inside it, it is not necessary to compute the distance to all elements inside or outside, respectively, and find the minimum. It is sufficient to work with surface elements only. These are in general much fewer. For example, a cube of 100 grid points along each edge contains one million points, but only sixty thousand surface points (six faces of 10,000 points each). Thus, finding the distance to the surface of the cube, i.e., the six faces, significantly reduces the computational effort.

In particular, an explicit surface representation can greatly accelerate the rendering (visual display) of an object. Despite recent great technical advances, directly rendering a volume of several million point samples, with the interpolation required for acceptably smooth images, evaluation of transparency, etc., at every element is hard to do fast enough for interactive applications. The computations for “empty” elements around the object, and for interior elements which cannot contribute to the final image unless part of the object is cut away, is both wasted time and effort.

Depending upon the computing environment, different surface representations may be most useful. Many graphics cards are highly optimized for fast display of surfaces specified as sets of triangular faces (or of polygonal faces, which they routinely break up into triangles), but render volumes slowly if at all. Alternatively, a volume-oriented environment may make it more convenient to use surface voxels, rather than polygons. A mesh surface with a very large number of small polygons can be inconvenient to render, either haptically or visually, since each triangle must be dealt with (which is often impossible within the time constraints of haptic display), and polygons whose visually displayed images are less than one pixel wide can often create substantial difficulties for the anti-aliasing algorithms by which graphics systems display a smoother image. While mesh reduction techniques (such as, for example, that described at http://www.martinb.com/contacts/meshreduction.htm or in P. S. Heckbert and M. Garland, Survey of Surface Simplification Algorithms, Technical Report, Computer Science Dept., Carnegie Mellon University, 1997) can replace a surface by an approximation that uses many fewer polygons, this can come at a considerable cost in computation time.

A standard means for finding a triangulated surface which separates the “inside” and “outside” elements of a segmentation is the Marching Cubes algorithm. Other methods of constructing a separating surface are also known in the art, such as, for example H. H. Baker, Building Surfaces of Evolution: The Weaving Wall, Int. J Comp Vision 3, 51-71 (1989), and T. Poston, T-T Wong, and P-A Heng, Multiresolution Isosurface Extraction with Adaptive Skeleton Climbing, Computer Graphics Forum 17: 3, September 1998, pp. 137-148. However, the emphasis in all such methods is on separating elements with which values are associated, rather than separating whole voxels. Moreover, the surfaces created using conventional methods, such as Marching Cubes and its progeny, have difficulties in finding surfaces that are truly closed, generally leaving “holes” or unconnected portions in such surfaces.

A simple means to represent a surface by voxels is to list every inside voxel that has an outside voxel neighbor, or to list every outside voxel that has an inside voxel neighbor. While such an unstructured list can serve various uses, it can be inconvenient for many purposes. For example, since a surface separates inside and outside elements, it should be possible to characterize an element as being inside or outside without referring back to—and having to load in active memory—the original large volume bitmap or segmentation result. (Such characterization can be useful in, for example, feeling the object in a force-feedback environment which requires a different force result if a tool tip has penetrated the object. Force feedback requires response times under one millisecond, thus making long computations undesirable.) Such an inside/outside characterization is difficult with an unstructured boundary voxel list that obeys few mathematical assumptions. Moreover, it is not conveniently related to a triangulated surface generated in any standard way. Switching between surface representations can be a useful way of exploiting the advantages of both. (As an analogy, testing whether an element (x, y, z) is inside the volume of the cylinder x²+y²≦4 requires little calculation in this form, whereas expressing the identical cylinder in polar co-ordinates using the mapping (2 cos θ, 2 sin θ, l) generates (x, y, z) coordinates on the cylinder surface for any pair (θ, l) and is thus more convenient in drawing such cylinder surface as a mesh of points.)

### SUMMARY OF THE INVENTION

A system and method for creating a surface for an arbitrary segment of a three-dimensional data set are presented. In exemplary embodiments according to the present invention the method includes initially identifying a set of surface voxels of the segment. For each voxel in the set information as to which of its neighbors are inside voxels can be obtained, and the results can be utilized to determine the location and direction of a polygonal surface dividing the voxel. The surface can be obtained by connecting all of the polygonal surfaces. In exemplary embodiments according to the present invention the polygonal surfaces can comprise triangles. In exemplary embodiments according to the present invention the surface can be displayed in either a wireframe mode or a solid mode. In exemplary embodiments according to the present invention mesh reduction can be implemented to reduce the number of polygons in the final surface. In exemplary embodiments of the present invention the volume bounded by the mesh surface can be calculated. Additionally, if the mesh surface generated is not a closed surface, as when, for example, the segmented object has been cropped prior to generation of the mesh surface, any “holes” within it can be closed by a hole closing algorithm and then the volume can be calculated.

### BRIEF DESCRIPTION OF THE DRAWINGS

FIG. 1 illustrates an exemplary 2D area enclosed by a circle that is mismeasured by about ten percent (10%) by simply counting enclosed grid points;

FIG. 2 illustrates an indentation in a 2D surface and subdivision of the adjacent voxel surface according to an exemplary embodiment of the present invention;

FIG. 3 illustrates an exemplary process flow according to an exemplary embodiment of the present invention;

FIG. 4A illustrates an exemplary 3D data set voxel and its twenty-six neighbors;

FIG. 4B illustrates the six direct neighbors of the voxel of FIG. 4A;

FIG. 5 illustrates exemplary inside voxels according to an exemplary embodiment of the present invention;

FIG. 6 illustrates in 2D the notion of the ‘interior’ of a point set;

FIG. 7 depicts exemplary patterns in 2D by which a candidate bounding element may have neighbors in and out of the set for which a surface is to be constructed according to an exemplary embodiment of the present invention;

FIG. 8 illustrates in both 2D and 3D a labeling scheme for the sides of a square and its exemplary use in specifying pieces of boundary that correspond to particular patterns of neighboring pixels or voxels, as the case may be;

FIG. 9 depicts an exemplary surface voxel division where the voxel's left direct neighbor is inside the segment according to an exemplary embodiment of the present invention;

FIG. 10 depicts an exemplary surface voxel division where the voxel's left direct neighbor and bottom direct neighbor are each inside the segment according to an exemplary embodiment of the present invention;

FIG. 11 depicts an exemplary edge labeling scheme for a voxel according to an exemplary embodiment of the present invention;

FIG. 12 depicts an exemplary voxel surface “groove” structure in 3D according to an exemplary embodiment of the present invention;

FIG. 13 depicts an exemplary refilling of the groove structure of FIG. 12, according to an exemplary embodiment of the present invention;

FIG. 14 depicts subdivision according to an exemplary embodiment of the present invention;

FIG. 15 depicts interpolation according to an exemplary embodiment of the present invention;

FIGS. 16-41 depict various exemplary surfaces generated according to the methods of exemplary embodiments of the present invention;

FIG. 42 depicts an exemplary solid mode surface generated without mesh reduction according to an exemplary embodiment of the present invention;

FIG. 43 depicts an exemplary vertex within a surface voxel according to an exemplary embodiment of the present invention;

FIG. 44 illustrates merging vertices according to an exemplary embodiment of the present invention;

FIG. 45 depicts inversion of a normal vector to a triangle as a result of a proposed vertex merging according to an exemplary embodiment of the present invention;

FIG. 46 depicts a “thin” triangle according to an exemplary embodiment of the present invention;

FIG. 47 depicts merging of two adjacent vertices according to an exemplary embodiment of the present invention;

FIG. 48 depicts exemplary boundary vertices according to an exemplary embodiment of the present invention;

FIGS. 49-50 depict an exemplary subdivided area of a surface according to an exemplary embodiment of the present invention;

FIGS. 51-52 depict removing vertices generated from subdivision according to an exemplary embodiment of the present invention;

FIGS. 53 and 54 illustrate certain special cases to be considered in mesh reduction according to an exemplary embodiment of the present invention;

FIGS. 55-63 illustrate hole closing and volume measurement according to an exemplary embodiment of the present invention; and

FIG. 64 depicts the assumptions and orientational definitions for the exemplary detailed pseudocode provided below according to an exemplary embodiment of the present invention.

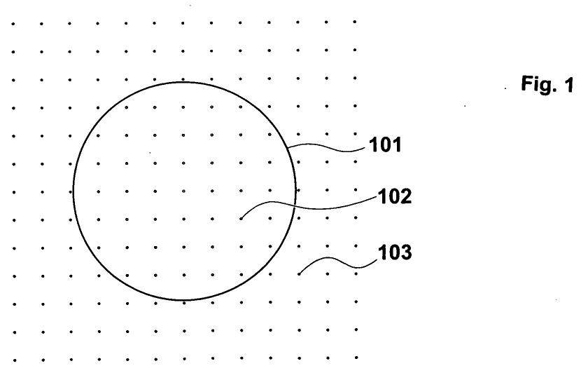

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

The present invention is directed to a system and method for constructing a voxel surface which fully encloses an arbitrary segment of a 3D data set. A voxel surface is a set of elements containing surface voxels, together with some additional data satisfying certain mathematical assumptions. The data structure and properties of the voxel surface construct permit the further construction of a mesh surface therefrom whose triangles or other polygons lie strictly within the individual voxels of the voxel surface (as distinct from being surrounded by the voxel surface, as is the case with inside voxels), with a triangle count similar to that obtained in Marching Cubes. The construction crosses each voxel with a piece of surface that is connected and simply connected: to make this possible, certain voxels must be subdivided or (usually less desirably) ‘filled in’ to become voxels of the segment rather than the surface.

This mesh surface shares with the voxel surface the property of separating points inside the latter from points outside it, in that any continuous path between and inside and an outside point must meet at least one of the triangles of the mesh. For any point (x, y, z), distance from the mesh surface and distance from the voxel surface (defined as the least distance from that point to a center of a voxel that is an element of the voxel surface) is within half a voxel diameter of its distance from the mesh surface (defined as the least distance from that point to a point of a mesh surface triangle). The two surface models can thus be used in close coordination, changing models where convenient.

In exemplary embodiments of the present invention a mesh surface can be rendered to a user's vision or to force-feedback touch sense by means well known to those skilled in the art. A voxel surface can be rendered by various means such as, for example, ‘splatting’ (see, for example, P. Schroeder & J. B. Salem, Fast Rotation of Volume Data on Data Parallel Architecture, Proceedings of Visualization '91, San Diego, Calif., 50-57, October 1991, K. Mueller & R. Yagel, Fast Perspective Volume Rendering with Splatting by Utilizing a Ray-Driven Approach, Proceedings 1996 Symposium on Volume Visualization, San Francisco, Calif., September 1996, pp. 65-72), whose cost in computation time is proportional to the number of voxels cast: typically, in this case, many fewer than the entire scan. Since the number of surface voxels is typically less than half the number of triangles in the corresponding surface mesh, this can yield a faster display of the object.

In exemplary embodiments of the present invention the following fast algorithm can determine whether a point (x, y, z) is inside or outside the voxel surface: step along, for example, the x direction until meeting a surface voxel (a faster condition to test than meeting a triangle), upon which the data structure of the surface can give a very fast decision as to whether the arriving step was from inside or outside. User interactions that modify the volume data, such as editing or simulated drilling, can thus be based on the voxel surface alone, requiring fewer data in memory and enabling higher performance.

A voxel surface can be used to modify voxel values from an original volume bitmap, creating a version in which the surface appears differently in a display. For example, color values from photographs may be projected onto these points so that the same volume rendering which reveals interior or cross-sectional information (such as brain or bone structure) can display skin in a natural color, without the performance cost of separately displaying a mesh surface. Where this is combined with changes of shape, such as those in planned cosmetic surgery, a result can be better visualized.

1. Assumptions and Terminology

For ease of illustration, a rectangular grid of voxels indexed by triples (i, j, k) of integers with 0≦i≦L, 0≦j≦M, 0≦k≦N is assumed. An element with i=0 or L, with j=0 or M, or with k=0 or N, is referred to as a boundary element of the grid. Many points of the description below can be most easily motivated by an analogous two dimensional case, where the corresponding structure is a grid of pixels (or picture elements) indexed by pairs (i, j) of integers. Although the construction of bounding curves in 2D is significantly simpler problem than constructing bounding surfaces in 3D, the logic of the method according to exemplary embodiments of the present invention is applicable in any dimension. Thus, it may be extended by one skilled in the art to the construction of a boundary hypersurface in four or more dimensions. (A typical four-dimensional data set can be generated, for example, by a succession of scans of a changing system, and indexed by quadruples (i, j, k, t) of integers identifying both the position and time to which a value refers.) For generality therefore, pixels, voxels and their higher-dimensional analogues will sometimes be referred to herein as elements, when making statements that are true regardless of dimension.

In a grid that is equally spaced in all three directions the axis-parallel grid-step can conveniently chosen as a unit of length. A voxel has 6 neighbors whose centers are at distance 1 from its own, whose surrounding voxels share a face with that voxel, 12 neighbors at distance \sqrt{2}, whose surrounding voxels share an edge with it, and 8 neighbors at distance \sqrt{3}, whose surrounding voxels share only a corner with it. Identifying grid points with their surrounding elements (pixels, voxels, or their higher dimensional analogues) they may be thus referred to as face neighbors, edge neighbors and corner neighbors, respectively, of the grid point or element. All of them are neighbors of it. Two neighbors of the element are opposite if the line joining them passes through the element. (It thus follows that a pair of opposite neighbors must be neighbors of the same type: face, edge or corner.)

2. Subdivision

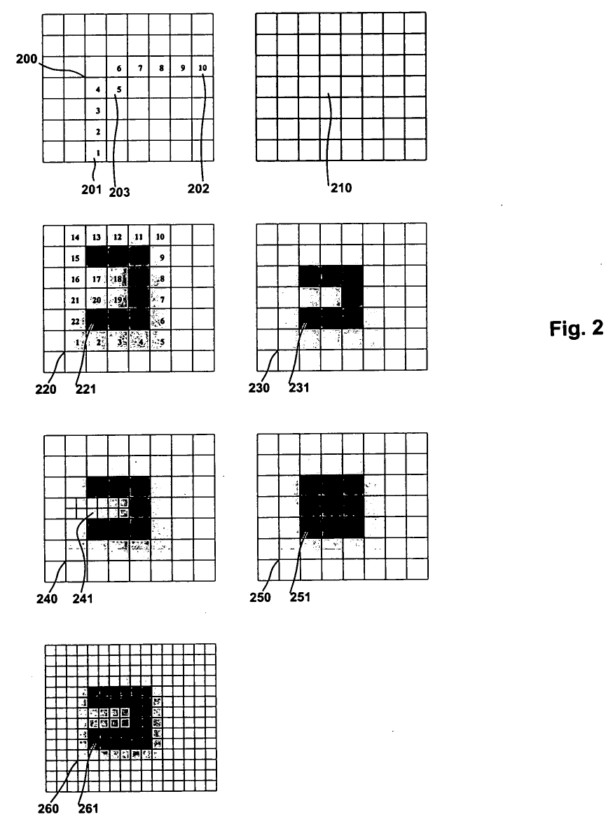

Subdivision of a voxel can be necessary when it is ambiguous as to where to place the polygonal surface which divides it to approximate the boundary of the object. With reference to FIG. 2, the dark gray region 231 of inside voxels, because of the groove structure within it, makes it difficult to divide each of the outside voxels which are “inside” the groove using polygonal surfaces (and thus non-curved dividing surfaces) and preserve the indentation of the object surface. This is because, as shall be developed more fully below, within the set 230 of elements neighboring it the two depicted voxels within the groove have inside voxel neighbors on each side of the Y direction, leading to ambiguous results. This is because in a division system where an object boundary is posited to cut a voxel surface (grey voxels 230) half way between a neighboring inside voxel (231) and a neighboring outside voxel (the white voxels in FIG. 2), for the voxel surface voxels in the “groove” of object 231 there is nowhere to place the posited object boundary. There is no voxel with one face neighbor being an inside voxel and the other being an outside voxel.

In exemplary embodiments according to the present invention, various means of dealing with this difficulty are available. One means is to subdivide each n-dimensional element into 2″ smaller elements (four smaller pixels for a pixel, eight smaller voxels for a voxel, etc.). Voxel path 241 is made possible by this technique. (It is noted that the definition of “face neighbor” now has to include the case of unequally sized elements.) Here each new voxel has an inside and an outside neighbor. The inside neighbors being elements of the dark object 231 and the outside neighbors being one of the subdivided groove voxels. The border can be posited to run across each groove voxel 241, thus preserving the actual boundary of the object. In effect subdivision transforms the situation of surface voxels 230 into that of 220 by subdividing each ambiguous groove voxel. Alternatively, the elements that create difficulty can be, for example, “filled in” and this can simply obviate the ambiguity. The voxel path 250 surrounds an enlarged version 251 of the region 231, and can be easily divided. It is noted that an element creates difficulty if it is not in the segment and the set of neighbors that are in the segment touch the element in two regions that do not touch (as is the case with objects having “grooves” and “cavities” one voxel wide such as 231 in FIG. 2). Moving such ambiguous elements into the segment can cause previously simple elements to have this problem property, so that ‘filling in’ must be recursive. The construction described below positions surface vertices along cube edges by interpolation using voxel values, which works correctly only if all inside voxels have values above the threshold T, so that filling in must assign new values to the voxels as well as recategorize them. In exemplary embodiments according to the present invention a value T+ε, where ε is a small increment, gives good results. Alternatively, for example, if the mean of neighboring inside elements is above T+ε, such mean can be, for example, used instead.

Since filling in of a segment can cause an unacceptable loss of structural detail (as by blocking a one-element-wide passageway along which, for example, fluid in the imaged object might flow), in exemplary embodiments according to the present invention subdivision can be used. The set of neighbors of an arbitrary set of elements in any dimension greater than one may fail to constitute a surface which can be easily created using standard geometric computational methods, so one or other of these modifications can be applied.

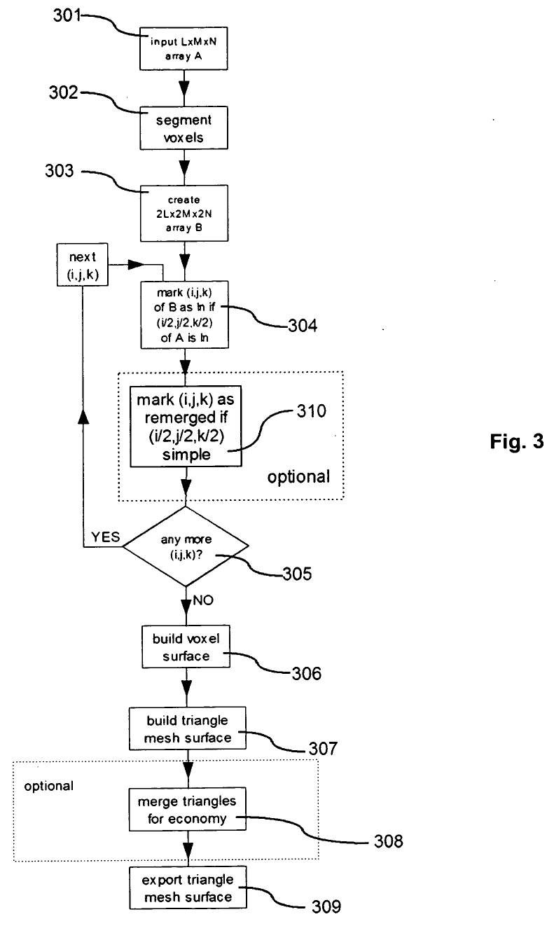

Subdivision can be performed in more than one way, as is illustrated in FIG. 3. After 301 where the scan data is imported and 302 where elements are classified as either In or Out, to construct a path such as 241, with reference to FIG. 2, or its analog in n dimensions, as in 260 with reference to FIG. 2, at 303, for example, all elements can be subdivided, and at 304, for example, new ones can be labeled as either In or Out according to the elements which they subdivided: i.e., each new (i, j, k) corresponds to an old (i/2, j/2, k/2) by integer division (discarding remainders) and similarly in other dimensions. Looping 305 completes this logic, after which, at 307, for example, a mesh surface can be created as described below, with or without 306 explicitly constructing as a data object the voxel surface in which it lies. However, because subdivision in 3D, for example, quadruples the triangle count, it can be useful to merge elements back to the larger elements, which is an available option in exemplary embodiments of the present invention. One simple way is, for example, to mark them at 310 as merged, without disturbing the enlarged array structure, skip marked elements with any coordinate element odd, and treat the fully-even ones as if they were the originals. It is noted that the enlarged array still takes 2″ times the memory of the original, so where memory is a limiting resource it may be preferable to, for example, construct a data structure that allocates additional memory only for the subdivided elements, connected by pointers to their originals, by a variety of known techniques.

In other exemplary embodiments according to the present invention, as an alternative to the distinction between divided and undivided elements, element-merging stage 310 can be omitted, and an exemplary system can, for example, work more simply with the 2″-times larger array (eight times larger, in 3D) as a data set with only simple elements. Since in 3D this produces four times as many triangles, it is likely to be useful at 308 to merge triangles within original elements, perhaps including a mesh reduction algorithm as above to further reduce the number of triangles, before at 309 exporting the final surface.

3. Surface Construction

Given a segmentation of the element set G into a set I of inside elements (inside voxels) and its complementary set O=G−I of outside elements, in exemplary embodiments of the present invention a voxel surface Σ can be constructed. For clarity, the method for the case of initial complete subdivision is described herein, though it may not be the most efficient in many cases. Other implementations will be best understood as modifications of it.

In exemplary embodiments of the present invention a candidate stack C can, for example, be created to contain every element in O that is a neighbor (of any type, face, edge or corner neighbor) of an element in I. These may be stored as a simple list of (i, j, k) values, as a run-length encoding of the elements in each line given by a particular (i, j), or otherwise by means known to those skilled in the art. This process can be achieved in several ways. For example, a first way is to iterate over all (i, j, k) in the volume bitmap, and for each voxel determine whether (i, j, k) is outside the segmentation and thus a candidate for being in C, and then whether it has an inside neighbor. A second way is, for example, to choose a ‘seed element’ that should be in C, test its neighbors and add to C those that belong there, test the neighbors of these additions, and continuing recursively in this fashion. After the further processing steps as described below this produces a connected surface, surrounding part of the segment or surrounding a cavity in it: The part of the segment surrounded is then connected also, unless it includes a cavity and a disconnected component within that cavity.

Table 1 lists exemplary variables which can be used for 2D cases. The meanings of variables eᵢ₋, eᵢ₊, eⱼ₋ and eⱼ₊ are provided in Table 1, and illustrate an exemplary schema for collecting neighboring voxel information. Here in 2D, of course, neighboring pixel information is what is collected. This information can be used, for example, to determine the shape, direction and location of a pixel boundary to approximate the boundary of the scanned object assumed contained in the segmented pixels.

TABLE 1
Exemplary 2D Neighbor Information Variables

| Name | Type | FALSE | TRUE |
|---|---|---|---|
| eᵢ₋ | boolean | Left direct neighbor | Left direct neighbor is inside |
| | | is outside | |
| eᵢ₊ | boolean | Right direct neighbor | Right direct neighbor is inside |
| | | is outside | |
| eⱼ₋ | boolean | Bottom direct neighbor | Bottom direct neighbor is |
| | | is outside | inside |
| eⱼ₊ | boolean | Top direct neighbor | Top direct neighbor is inside |
| | | is outside | |

What will be next described is the extension of this idea to three and greater dimensions. There is a tension between the actual object and the set of inside voxels obtained by a segmentation of scan data. Due to scan errors and resolution they are generally not spatially identical. An actual object can be wholly within a segmentation or can extend beyond it, depending upon whether the segmentation rule was “liberal” (more inclusive) and included voxels straddling a boundary of the actual object or “sparing” (restrictive) including only those voxels definitively within the actual object.

It is noted that it is generally assumed herein that inside voxels—as determined by an exemplary thresholding or segmentation—do not actually contain the actual boundary of the object. This assumption is equivalent to stating that the threshold was set sparingly such that the actual object contains, but extends beyond, some or all of the set of inside voxels, and the boundary—both interpolated and actual—will be within the surface voxels, or those voxels labeled as outside by the segmentation but having neighboring voxels that are inside voxels. Alternatively, the present invention also covers cases where the threshold is set liberally such that the inside voxels wholly contain the actual boundary of the actual object within them, and the boundary—both interpolated and actual—of the object will be within the (generally, within the outermost layer of) inside voxels. In the discussion that follows, for such cases, reversing the signs of ƒ and Twill apply to such “liberal” thresholds” where inside voxels are actually divided to generate a surface as opposed to outside surface voxels. In either case voxels are divided to approximate where the actual boundary of the actual object appears in the virtual voxel environment.

In exemplary embodiments of the present invention, to construct a surface relating to a given threshold, (i) those voxels that contain the surface must first be found. Then (ii) the shape of the surface within those voxels must be determined. Finally, (iii) exactly where the perimeter of the surface intersects the edges and faces of those voxels needs to be computed. The following description encompasses all of those tasks.

(1) Voxel Surface

In exemplary embodiments of the present invention there are two ways to find those voxels which contain the surface. The first, for example, is to go through every voxel in the volume data. Depending upon the voxel's value, it can be marked as either an inside voxel or outside voxel. An outside voxel is posited as an element of the voxel surface (i.e., as containing—the surface) if and only if it has at least one inside neighbor. Such voxels, defined as surface voxels, are those voxels that are assumed as penetrated by (i.e., containing) the surface.

Another exemplary method is to use, for example, a seed point to extract the voxel surface. A seed should be a surface voxel, whose six direct neighbors include either one inside voxel, two non-opposite inside voxels, or three inside voxels where no two of the three are opposite. For every surface voxel, it is necessary to check its 26 neighbors to find new surface voxels. Then each new surface voxel's 26 neighbors can be checked as well. This process can be continued until the twenty-six neighbors of each surface voxel have been checked.

The first approach can find surfaces of every object in the volume data. However, it often requires more time as it needs to process the entire volume. The second approach is generally a little faster, but it sometimes cannot find surfaces of all objects when the distances of those objects are bigger than two voxel sizes.

The above description speaks to a 3D case. For an analogous 2D case, a voxel can be replaced with a pixel and a surface can be replaced with a curve.

(2) Obtain Direct Neighbor Information for Each Surface Voxel

In exemplary embodiments of the present invention, once the set of surface voxels has been found, direct neighbor information can be collected for each surface voxel. Direct neighbor information tracks which neighbors of a surface voxel are inside the object, or are “inside voxels.” A direct neighbor of a given voxel is one that shares a full face with that voxel. Thus each voxel has six direct neighbor voxels.

To record the direct neighbor information of a surface voxel, for example, temporary Boolean variables can be assigned for each surface voxel. Those temporary variables can then be used for the next step to compute the shape information of the surface within a surface voxel. Thus, for every surface voxel, its Boolean variables can be computed.

Table 3 lists exemplary variables that can, for example, be used for 3D cases in this step. The meaning of variables eᵢ₋, eᵢ₊, eⱼ₋, eⱼ₊, eₖ₋, eₖ₊ and ε are provided in Table 3. Variables eᵢ₋, eᵢ₊, eⱼ₋, eⱼ₊, eₖ₋, eₖ₊ and ε can be, in an exemplary embodiment, initialized as FALSE.

TABLE 3
Exemplary Variables for Storing Direct-neighbor Information

| Name | Type | FALSE | TRUE |
|---|---|---|---|
| eᵢ₋ | boolean | Left direct neighbor is outside | Left direct neighbor is inside |
| eᵢ₊ | boolean | Right direct neighbor is outside | Right direct neighbor is inside |
| eⱼ₋ | boolean | Bottom direct neighbor is outside | Bottom direct neighbor is inside |
| eⱼ₊ | boolean | Top direct neighbor is outside | Top direct neighbor is inside |
| eₖ₋ | boolean | Back direct neighbor is outside | Back direct neighbor is inside |
| eₖ₊ | boolean | Front direct neighbor is outside | Front direct neighbor is inside |
| ε | boolean | No direct neighbors are inside | At least one direct neighbor is inside |

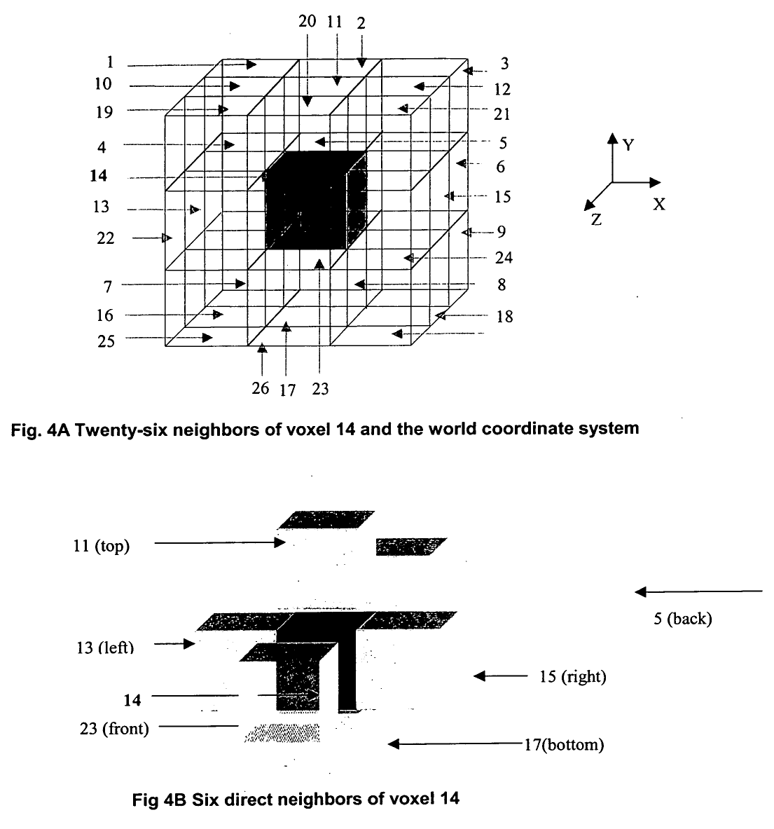

For illustration purposes, it is assumed that the current voxel being processed is voxel 14, a surface voxel. As shown in the example depicted in FIG. 4, voxel 14 has six direct neighbors, being voxels 13, 15, 17, 11, 5 and 23.

Exemplary computations of the temporary Boolean variables of Table 3 can, for example, be made as follows:
a) If the left neighbor 13 is inside, set eᵢ₋ to TRUE;
b) If the right neighbor 15 is inside, set eᵢ₊ to TRUE;
c) If the bottom neighbor 17 is inside, set eⱼ₋ to TRUE;
d) If the top neighbor 11 is inside, set eⱼ₊ to TRUE;
e) If the back neighbor 5 is inside, set eₖ₋ to TRUE;
f) If the front neighbor 23 is inside, set eₖ₊ to TRUE; and
g) If any of 13, 15, 17, 11, 5 or 23 is an inside voxel, set ε to TRUE, i.e., ε=eᵢ₋|eᵢ₊|eⱼ₋|e₋|eₖ₊, where ‘|’ means ‘or’, and where ε tracks whether any direct neighbors of a given voxel (in this case voxel 14) are inside voxels.

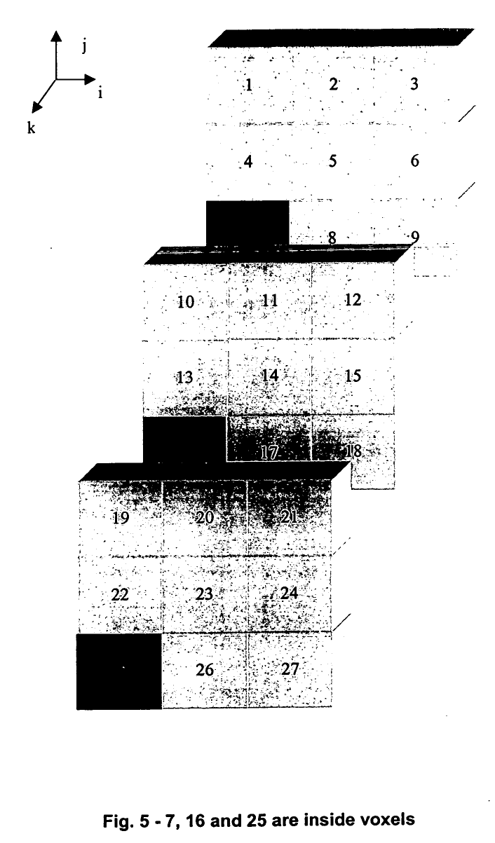

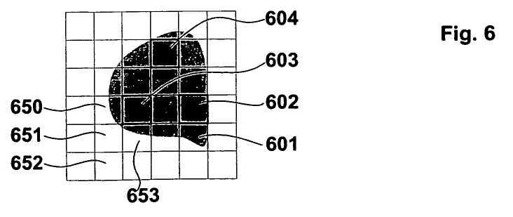

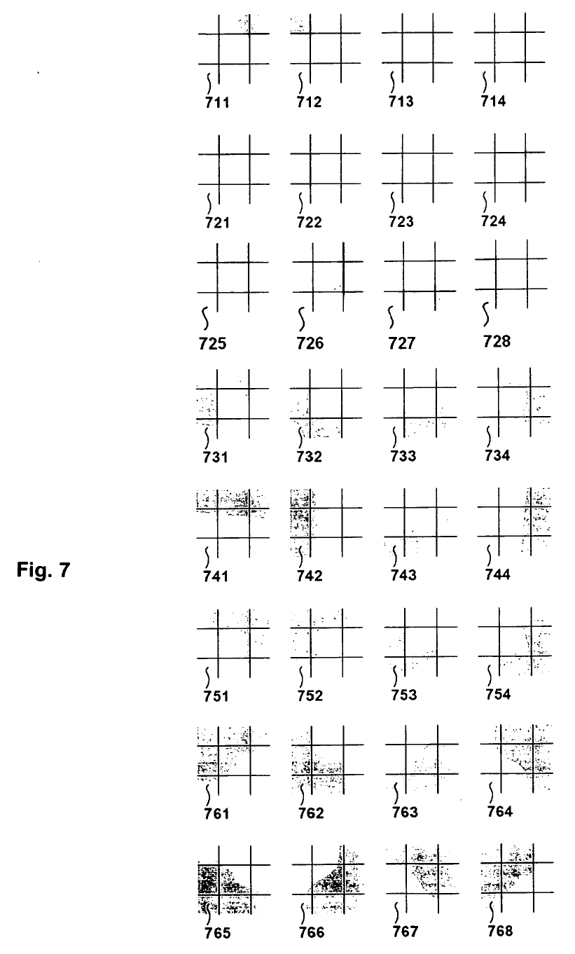

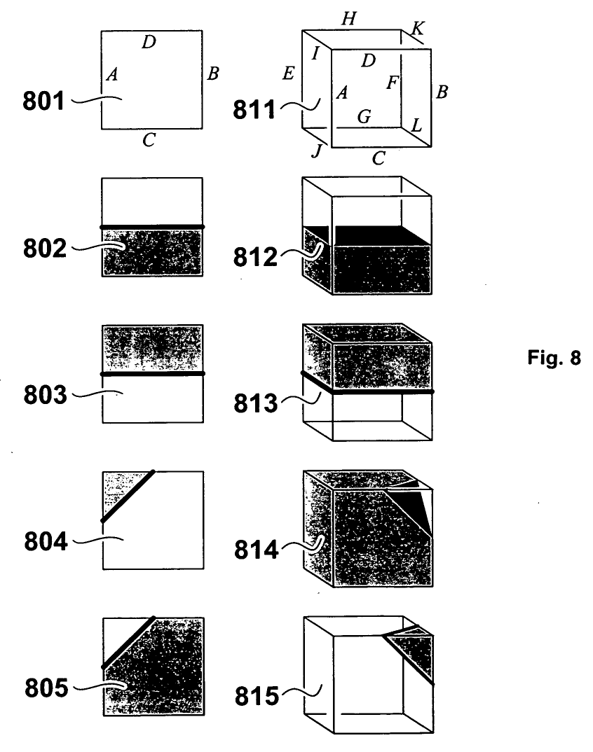

For example, using the voxel segmentation depicted in FIG. 5, after implementing the exemplary computation provided above, the following results can be obtained for voxels 4, 5, 8, 13, 14, 17, 22, 23, and 26 (only these voxels are presented here, as the remaining fifteen voxels in the depicted 3×3 volume are trivial cases, as they have no directly neighboring inside voxels):

TABLE 5
Direct Neighbor As Inside Voxel Information
(BLANK = FALSE)

| | eᵢ₋ | eᵢ₊ | eⱼ₋ | eⱼ₊ | eₖ₋ | eₖ₊ | ε |
|---|---|---|---|---|---|---|---|
| 4 | | | TRUE | | | | TRUE |
| 5 | | | | | | | |
| 8 | TRUE | | | | | | TRUE |
| 13 | | | TRUE | | | | TRUE |
| 14 | | | | | | | |
| 17 | TRUE | | | | | | TRUE |
| 22 | | | TRUE | | | | TRUE |
| 23 | | | | | | | |
| 26 | TRUE | | | | | | TRUE |

All possible direct neighbor cases for a given voxel are listed in Table 6 below. Corresponding to each entry in Table 6, Appendix I provides a pictorial description for each case and illustrates how the values of e and ε in Table 3 can be calculated as a function of the direct neighbors of a given voxel. In Appendix I an inside voxel is depicted as dark and an outside voxel as light.

TABLE 6
All Possible Cases for Direct Neighbors Of a Voxel Being Inside Voxels

| | eᵢ₋ | eᵢ₊ | eⱼ₋ | eⱼ₊ | eₖ₋ | eₖ₊ | ε |
|---|---|---|---|---|---|---|---|
| 0-1 | | | | | | | F |
| 1-1 | T | | | | | | T |
| 1-2 | | T | | | | | T |
| 1-3 | | | T | | | | T |
| 1-4 | | | | T | | | T |
| 1-5 | | | | | T | | T |
| 1-6 | | | | | | T | T |
| 2-1 | T | | T | | | | T |
| 2-2 | T | | | T | | | T |
| 2-3 | T | | | | T | | T |
| 2-4 | T | | | | | T | T |
| 2-5 | | T | T | | | | T |
| 2-6 | | T | | T | | | T |
| 2-7 | | T | | | T | | T |
| 2-8 | | T | | | | T | T |
| 2-9 | | | T | | T | | T |
| 2-10 | | | T | | | T | T |
| 2-11 | | | | T | T | | T |
| 2-12 | | | | T | | T | T |
| 2-13 | T | T | | | | | T |
| 2-14 | | | T | T | | | T |
| 2-15 | | | | | T | T | T |
| 3-1 | T | | T | | T | | T |
| 3-2 | T | | T | | | T | T |
| 3-3 | T | | | T | T | | T |
| 3-4 | T | | | T | | T | T |
| 3-5 | | T | T | | T | | T |
| 3-6 | | T | T | | | T | T |
| 3-7 | | T | | T | T | | T |
| 3-8 | | T | | T | | T | T |
| 3-9 | T | T | T | | | | T |
| 3-10 | T | T | | T | | | T |
| 3-11 | T | T | | | T | | T |
| 3-12 | T | T | | | | T | T |
| 3-13 | T | | T | T | | | T |
| 3-14 | | T | T | T | | | T |
| 3-15 | | | T | T | T | | T |
| 3-16 | | | T | T | | T | T |
| 3-17 | T | | | | T | T | T |
| 3-18 | | T | | | T | T | T |
| 3-19 | | | T | | T | T | T |
| 3-20 | | | | T | T | T | T |
| 4-1 | T | T | T | | T | | T |
| 4-2 | T | T | T | | | T | T |
| 4-3 | T | T | | T | T | | T |
| 4-4 | T | T | | T | | T | T |
| 4-5 | T | | T | T | T | | T |
| 4-6 | T | | T | T | | T | T |
| 4-7 | | T | T | T | T | | T |
| 4-8 | | T | T | T | | T | T |
| 4-9 | T | | T | | T | T | T |
| 4-10 | T | | | T | T | T | T |
| 4-11 | | T | T | | T | T | T |
| 4-12 | | T | | T | T | T | T |
| 4-13 | T | T | T | T | | | T |
| 4-14 | | | T | T | T | T | T |
| 4-15 | T | T | | | T | T | T |
| 5-1 | T | T | T | T | T | | T |
| 5-2 | T | T | T | T | | T | T |
| 5-3 | T | T | T | | T | T | T |
| 5-4 | T | T | | T | T | T | T |
| 5-5 | T | | T | T | T | T | T |
| 5-6 | | T | T | T | T | T | T |
| 6-1 | T | T | T | T | T | T | T |

### Table 6—All Possible Cases for Direct Neighbors Of a Voxel Being Inside Voxels

It is noted that although case 6-1 obviously refers to an inside voxel and thus not a member of a surface voxel set, it is retained because in some software implementations in exemplary embodiments of the present invention it is more efficient to check for this case than to exclude it from the processing loops.

(3) Shape Information of an Interpolated Surface Within a Surface voxel

The temporary direct neighbor Boolean variables do not strictly contain enough information to construct a surface with good connectivity. For example, in FIG. 5, assume that only Voxel 16 is inside. While the shape information of a surface within Voxels 13 and 17 is known, nothing is known about Voxel 14. Thus, it is difficult to connect the surface within 13 with that within 17. This is because since Voxel 14 has no direct neighbors it has no e or ε values as defined in Table 3; however, it has an indirect neighbor in voxel 16, so the surface should cut across the lower left corner of Voxel 14 (in similar fashion as how positing a border through surface voxels 201 in FIG. 2 would cut across the bottom right corner of voxel 4, the top left corner of voxel 5 and the bottom right corner of voxel 6, for an object whose inside voxels were in the bottom right corner of the grid in the first frame of FIG. 2). In fact, the correct surface to divide Voxel 14 in this case is provided in Appendix III, Case 3, at page 3. What therefore needs to be done is to share neighbor information among adjacent surface voxels, as next described.

Thus, for example, new exemplary variables can be defined for every surface voxel to record its original neighbor information as well as neighbor information which is shared with the voxel by its neighboring voxels, as listed in Table 7 below. In exemplary embodiments of the present invention Boolean variables can be initialized as FALSE, for example, and integer variables can, for example, be initialized as 0.

TABLE 7
Exemplary Variables for Storing Neighbor Information

| name | type | FALSE | TRUE |
|---|---|---|---|
| ƒᵢ₋ | boolean | No extension along +x | Extended along +x direction |
| | | direction | |
| ƒᵢ₊ | boolean | No extension along −x | Extended along −x direction |
| | | direction | |
| ƒⱼ₋ | boolean | No extension along +y | Extended along +y direction |
| | | direction | |
| ƒⱼ₊ | boolean | No extension along −y | Extended along −y direction |
| | | direction | |
| ƒₖ₋ | boolean | No extension along +z | Extended along +z direction |
| | | direction | |
| ƒₖ₊ | boolean | No extension along −z | Extended along −z direction |
| | | direction | |
| \overline{ε}ᵢ | integer | Number of face neighbors from which eᵢ₋ or eᵢ₊ is | |
| | | True and extends to current voxel value ƒᵢ₋ or ƒᵢ₊. | |
| \overline{ε}ⱼ | integer | Number of face neighbors from which eⱼ₋ or eⱼ₊ is | |
| | | True and extends to current voxel value ƒⱼ₋ or ƒⱼ₊. | |
| \overline{ε}ₖ | integer | Number of face neighbors from which eₖ₋ or eₖ₊ is | |
| | | True and extends to current voxel value ƒₖ₋ or ƒₖ₊. | |
| ε | boolean | No direct neighbors | At least one direct neighbor |
| | | are inside | is inside |

### Table 7—Exemplary Variables for Storing Neighbor Information

It is noted that a shared face between a surface voxel and an inside voxel will never be cut by the surface nor will the four edges of that shared face ever be cut (i.e., intersected) by the surface. This is, as described above, because to be a surface voxel, some portion of the object is be assumed to be contained within it. Thus, the surface is assumed to run through a surface voxel. (Or alternatively, for liberal thresholds, as noted above, the object boundary is assumed to be somewhere within the outermost inside voxels, and it runs through those inside voxels but not through the boundary between an outermost inside voxel and its neighboring inside voxels).

For example, assume the currently processed voxel is voxel 14 (i, j, k), a surface voxel (as it has inside neighbors—an edge neighbor 16 and two corner neighbors 25 and 7), as shown in FIG. 5. The variables as defined in Table 7 can be, for example, computed for voxel 14 as follows:
If eᵢ₋(i, j, k) is TRUE,
set ƒᵢ₋(i, j, k) to be TRUE;

The following 4 conditions are for face neighbors 5 (i, j, k−1), 23 (i, j, k+1), 11 (i, j+1, k) and 17(i, j−1, k) of voxel 14. The other 2 face neighbors 13 (i−1, j, k) and 15 (i+1, j, k) will never share their eᵢ₋ and eᵢ₊ information to 14, because the faces they share with 14 are perpendicular to the i direction and thus any eᵢ₋ and eᵢ₊ information they have is for voxels outside of the 3×3 neighborhood of voxel 14. These 4 conditions insure that the surface within neighbors 5, 23, 11, 17 will continuously connect the surface within 14. For example, if the front face of voxel 5 is cut by the surface, the following first condition will pass this information to voxel 4, which will cause that the back face of voxel 14 will also be cut by the surface.
else if eᵢ₋(i, j−1, k) is TRUE
set ƒᵢ₋(i, j, k) to be TRUE; (tests voxel 17)
else if eᵢᵢ₋(i, j+1, k) is TRUE
set ƒᵢ₋(i, j, k) to be TRUE; (tests voxel 11)
else if eᵢ₋(i, j, k−1) is TRUE
set ƒᵢ₋(i, j, k) to be TRUE; (tests voxel 5)
else if eᵢ₋(i, j, k+1) is TRUE
set ƒᵢ₋(i, j, k) to be TRUE; (tests voxel 23)

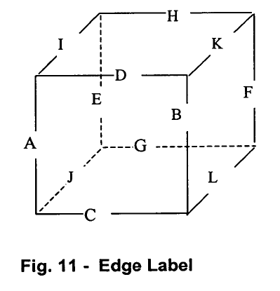

The following 4 conditions are for edge neighbors 2 (i, j+1, k−1), 8 (i, j−1, k−1), 20 (i, j+1, k+1) and 26 (i, j−1, k+1), because the edges they share with voxel 14 are parallel to the i direction (FIG. 11 provides the edge labeling nomenclature used in what follows). For neighbor 8, which shares its edge D with 14, if its eᵢ₋ value is TRUE, it is possible to share this information to the ƒᵢ₋ value of voxel 14. If eⱼ₊ of 8 is TRUE, which means voxel 5 is an inside voxel, so the edge indicates the edge D of 8 will not be cut by the surface, the information share is not necessary and thus need not happen. Similarly, if eₖ₊ of 8 is TRUE, the information share will not happen.
else if eᵢ₋(i, j−1, k−1) is TRUE .and. eⱼ₊(i, j−1, k−1) is FALSE .and. eₖ₊(i, j−1, k−1) is FALSE
set ƒᵢ₋(i, j, k) to be TRUE; (tests voxel 8)
else if eᵢ₋(i, j−1, k+1) is TRUE.and. eᵢ₊(i, j−1, k+1) is FALSE .and. eₖ₋(i, j−1, k+1) is FALSE
set ƒᵢ₋(i, j, k) to be TRUE; (tests voxel 26)
else if eᵢ₋(i, j+1, k+1) is TRUE .and. eⱼ₋(i, j+1, k+1) is FALSE .and. eₖ₋(i, j+1, k+1) is FALSE
set ƒᵢ₋(i, j, k) to be TRUE; (tests voxel 2)
else if eᵢ₋(i, j+1, k−1) is TRUE .and. eⱼ₋(i, j+1, k−1) is FALSE .and. eₖ₊(i, j+1, k−1) is FALSE
set ƒᵢ₋(i, j, k) to be TRUE; (tests voxel 20)
else;

The above conditions can be summarized in the following single formula.

$$Equation 1 \text{:} \\ \begin{matrix}{f}_{i -} ( i , j , k ) = {e}_{i -} ( i , j , k ) \\ ‖ {e}_{i -} ( i , j - 1 , k ) ‖ {e}_{i -} ( i , j + 1 , k ) \\ ‖ {e}_{i -} ( i , j , k - 1 ) ‖ {e}_{i -} ( i , j , k + 1 ) \\ ‖ ( ( {e}_{j +} ( i , j - 1 , k - 1 ) ⩵ false ) \&\& \\ ( {e}_{k +} ( i , j - 1 , k - 1 ) ⩵ false ) \&\& ( {e}_{i -} ( i , j - 1 , k - 1 ) ) ) \\ ‖ ( ( {e}_{j +} ( i , j - 1 , k + 1 ) ⩵ false ) \&\& \\ ( {e}_{k -} ( i , j - 1 , k + 1 ) ⩵ false ) \&\& ( {e}_{i -} ( i , j - 1 , k + 1 ) ) ) \\ ‖ ( ( {e}_{j -} ( i , j + 1 , k - 1 ) ⩵ false ) \&\& \\ ( {e}_{k +} ( i , j + 1 , k - 1 ) ⩵ false ) \&\& ( {e}_{i -} ( i , j + 1 , k - 1 ) ) ) \\ ‖ ( ( {e}_{j -} ( i , j + 1 , k + 1 ) ⩵ false ) \&\& \\ ( {e}_{k -} ( i , j + 1 , k + 1 ) ⩵ false ) \&\& ( {e}_{i -} ( i , j + 1 , k + 1 ) ) )\end{matrix}$$

And similarly for ƒᵢ₊(i, j, k), ƒⱼ₋(i, j, k), ƒⱼ₊(i, j, k), ƒₖ₋(i, j, k) and ƒₖ₊(i, j, k):

$$\begin{matrix}Equation 2 \text{:} \\ \begin{matrix}{f}_{i +} ( i , j , k ) = {e}_{i +} ( i , j , k ) \\ ‖ {e}_{i +} ( i , j - 1 , k ) ‖ {e}_{i +} ( i , j + 1 , k ) \\ ‖ {e}_{i +} ( i , j , k - 1 ) ‖ {e}_{i +} ( i , j , k + 1 ) \\ ‖ ( ( {e}_{j +} ( i , j - 1 , k - 1 ) ⩵ false ) \&\& \\ ( {e}_{k +} ( i , j - 1 , k - 1 ) ⩵ false ) \&\& ( {e}_{i +} ( i , j - 1 , k - 1 ) ) ) \\ ‖ ( ( {e}_{j +} ( i , j - 1 , k + 1 ) ⩵ false ) \&\& \\ ( {e}_{k -} ( i , j - 1 , k + 1 ) ⩵ false ) \&\& ( {e}_{i +} ( i , j - 1 , k + 1 ) ) ) \\ ‖ ( ( {e}_{j -} ( i , j + 1 , k - 1 ) ⩵ false ) \&\& \\ ( {e}_{k +} ( i , j + 1 , k - 1 ) ⩵ false ) \&\& ( {e}_{i +} ( i , j + 1 , k - 1 ) ) ) \\ ‖ ( ( {e}_{j -} ( i , j + 1 , k + 1 ) ⩵ false ) \&\& \\ ( {e}_{k -} ( i , j + 1 , k + 1 ) ⩵ false ) \&\& ( {e}_{i +} ( i , j + 1 , k + 1 ) ) )\end{matrix} & \\ Equation 3 \text{:} \\ \begin{matrix}{f}_{j -} ( i , j , k ) = {e}_{j -} ( i , j , k ) \\ ‖ {e}_{j -} ( i - 1 , j , k ) ‖ {e}_{j -} ( i + 1 , j , k ) \\ ‖ {e}_{j -} ( i , j , k - 1 ) ‖ {e}_{j -} ( i , j , k + 1 ) \\ ‖ ( ( {e}_{i +} ( i - 1 , j , k - 1 ) ⩵ false ) \&\& \\ ( {e}_{k +} ( i - 1 , j , k - 1 ) ⩵ false ) \&\& ( {e}_{j -} ( i - 1 , j , k - 1 ) ) ) \\ ‖ ( ( {e}_{i +} ( i - 1 , j , k + 1 ) ⩵ false ) \&\& \\ ( {e}_{k -} ( i - 1 , j , k + 1 ) ⩵ false ) \&\& ( {e}_{j -} ( i - 1 , j , k + 1 ) ) ) \\ ‖ ( ( {e}_{i -} ( i + 1 , j , k - 1 ) ⩵ false ) \&\& \\ ( {e}_{k +} ( i + 1 , j , k - 1 ) ⩵ false ) \&\& ( {e}_{j -} ( i + 1 , j , k - 1 ) ) ) \\ ‖ ( ( {e}_{i -} ( i + 1 , j , k + 1 ) ⩵ false ) \&\& \\ ( {e}_{k -} ( i + 1 , j , k + 1 ) ⩵ false ) \&\& ( {e}_{j -} ( i + 1 , j , k + 1 ) ) )\end{matrix} & \\ Equation 4 \text{:} \\ \begin{matrix}{f}_{j +} ( i , j , k ) = {e}_{j +} ( i , j , k ) \\ ‖ {e}_{j +} ( i - 1 , j , k ) ‖ {e}_{j +} ( i + 1 , j , k ) \\ ‖ {e}_{j +} ( i , j , k - 1 ) ‖ {e}_{j +} ( i , j , k + 1 ) \\ ‖ ( ( {e}_{i +} ( i - 1 , j , k - 1 ) ⩵ false ) \&\& \\ ( {e}_{k +} ( i - 1 , j , k - 1 ) ⩵ false ) \&\& ( {e}_{j +} ( i - 1 , j , k - 1 ) ) ) \\ ‖ ( ( {e}_{i +} ( i - 1 , j , k + 1 ) ⩵ false ) \&\& \\ ( {e}_{k -} ( i - 1 , j , k + 1 ) ⩵ false ) \&\& ( {e}_{j +} ( i - 1 , j , k + 1 ) ) ) \\ ‖ ( ( {e}_{i -} ( i + 1 , j , k - 1 ) ⩵ false ) \&\& \\ ( {e}_{k +} ( i + 1 , j , k - 1 ) ⩵ false ) \&\& ( {e}_{j +} ( i + 1 , j , k - 1 ) ) ) \\ ‖ ( ( {e}_{i -} ( i + 1 , j , k + 1 ) ⩵ false ) \&\& \\ ( {e}_{k -} ( i + 1 , j , k + 1 ) ⩵ false ) \&\& ( {e}_{j +} ( i + 1 , j , k + 1 ) ) )\end{matrix} & \\ Equation 5 \text{:} \\ \begin{matrix}{f}_{k -} ( i , j , k ) = {e}_{k -} ( i , j , k ) \\ ‖ {e}_{k -} ( i - 1 , j , k ) ‖ {e}_{k -} ( i + 1 , j , k ) \\ ‖ {e}_{k -} ( i , j - 1 , k ) ‖ {e}_{k -} ( i , j + 1 , k ) \\ ‖ ( ( {e}_{i +} ( i - 1 , j - 1 , k ) ⩵ false ) \&\& \\ ( {e}_{j +} ( i - 1 , j - 1 , k ) ⩵ false ) \&\& ( {e}_{k -} ( i - 1 , j - 1 , k ) ) ) \\ ‖ ( ( {e}_{i +} ( i - 1 , j + 1 , k ) ⩵ false ) \&\& \\ ( {e}_{j -} ( i - 1 , j + 1 , k ) ⩵ false ) \&\& ( {e}_{k -} ( i - 1 , j + 1 , k ) ) ) \\ ‖ ( ( {e}_{i -} ( i + 1 , j - 1 , k ) ⩵ false ) \&\& \\ ( {e}_{j +} ( i + 1 , j - 1 , k ) ⩵ false ) \&\& ( {e}_{k -} ( i + 1 , j - 1 , k ) ) ) \\ ‖ ( ( {e}_{i -} ( i + 1 , j + 1 , k ) ⩵ false ) \&\& \\ ( {e}_{j -} ( i + 1 , j - 1 , k ) ⩵ false ) \&\& ( {e}_{k -} ( i + 1 , j + 1 , k ) ) )\end{matrix} & \\ Equation 6 \text{:} \\ \begin{matrix}{f}_{k +} ( i , j , k ) = {e}_{k +} ( i , j , k ) \\ ‖ {e}_{k +} ( i - 1 , j , k ) ‖ {e}_{k +} ( i + 1 , j , k ) \\ ‖ {e}_{k +} ( i , j - 1 , k ) ‖ {e}_{k +} ( i , j + 1 , k ) \\ ‖ ( ( {e}_{i +} ( i - 1 , j - 1 , k ) ⩵ false ) \&\& \\ ( {e}_{j +} ( i - 1 , j - 1 , k ) ⩵ false ) \&\& ( {e}_{k +} ( i - 1 , j - 1 , k ) ) ) \\ ‖ ( ( {e}_{i +} ( i - 1 , j + 1 , k ) ⩵ false ) \&\& \\ ( {e}_{j -} ( i - 1 , j + 1 , k ) ⩵ false ) \&\& ( {e}_{k +} ( i - 1 , j + 1 , k ) ) ) \\ ‖ ( ( {e}_{i -} ( i + 1 , j - 1 , k ) ⩵ false ) \&\& \\ ( {e}_{j +} ( i + 1 , j - 1 , k ) ⩵ false ) \&\& ( {e}_{k +} ( i + 1 , j - 1 , k ) ) ) \\ ‖ ( ( {e}_{i -} ( i + 1 , j + 1 , k ) ⩵ false ) \&\& \\ ( {e}_{j -} ( i + 1 , j - 1 , k ) ⩵ false ) \&\& ( {e}_{k +} ( i + 1 , j + 1 , k ) ) )\end{matrix} & \end{matrix}$$

For the \overline{ε}ᵢ(i, j, k) values of Table 7, they indicate the number of face neighbors from which eᵢ₋ or eᵢ₊ is True and extends to current voxel value ƒᵢ₋ or ƒᵢ₊. It can be computed, for example, as follows:
1) If both ƒᵢ₋(i, j, k) and ƒᵢ₊(i, j, k) are TRUE, or both ƒᵢ₋(i, j, k) and ƒᵢ₊(i, j, k) are TRUE, or both ƒᵢ₋(i, j, k) and ƒᵢ₊(i, j, k) are TRUE, no need to compute \overline{ε}ᵢ(i, j, k), \overline{ε}ⱼ(i, j, k), \overline{ε}ₖ(i, j, k), because voxel (i, j, k) needs post-processing.
2) If eᵢ₋(i, j, k) is TRUE, or eᵢ₊(i, j, k) is TRUE, set \overline{ε}ᵢ(i, j, k) as 0;
else if ƒᵢ₋(i, j, k) is true, compute the number of TRUE value among eᵢ₋(i, j−1, k), eᵢ₋(i, j+1, k), e₋(i, j, k−1) and eᵢ₋(i, j, k+1), set the number to \overline{ε}ᵢ(i, j, k);
else if ƒᵢ₊(i, j, k) is true, compute the number of TRUE value among eᵢ₊(i, j−1, k), eᵢ₊(i, j+1, k), eᵢ₊(i, j, k−1) and eᵢ₊(i, j, k+1), set the number to \overline{ε}ᵢ(i, j, k);
else set \overline{ε}ᵢ(i, j, k) as 0.

The values for \overline{ε}ⱼ(i, j, k) and \overline{ε}ₖ(i, j, k) can be computed in a similar fashion. For example, as shown in FIG. 5, after the above processing, Table 8 can be obtained:

TABLE 8

| | fᵢ₋ | fᵢ₊ | fⱼ₋ | fⱼ₊ | fₖ₋ | fₖ₊ | \overline{ε}ᵢ | \overline{ε}ⱼ | \overline{ε}ₖ |
|---|---|---|---|---|---|---|---|---|---|
| 4 | | | TRUE | | | | 0 | 0 | 0 |
| 5 | TRUE | | TRUE | | | | 1 | 1 | 0 |
| 8 | TRUE | | | | | | 0 | 0 | 0 |
| 13 | | | TRUE | | | | 0 | 0 | 0 |
| 14 | TRUE | | TRUE | | | | 1 | 1 | 0 |
| 17 | TRUE | | | | | | 0 | 0 | 0 |
| 22 | | | TRUE | | | | 0 | 0 | 0 |
| 23 | TRUE | | TRUE | | | | 1 | 1 | 0 |
| 26 | TRUE | | | | | | 0 | 0 | 0 |

Without consideration of cases needing post-processing, as described below, all possible cases are thus summarized in Table 9 below.

TABLE 9

| | fᵢ₋ | fᵢ₊ | fⱼ₋ | fⱼ₊ | fₖ₋ | fₖ₊ | \overline{ε}ᵢ | \overline{ε}ⱼ | \overline{ε}ₖ | ε |
|---|---|---|---|---|---|---|---|---|---|---|
| 1-1 | T | | | | | | 0 | 0 | 0 | T |
| 1-2 | | T | | | | | 0 | 0 | 0 | T |
| 1-3 | | | T | | | | 0 | 0 | 0 | T |
| 1-4 | | | | T | | | 0 | 0 | 0 | T |
| 1-5 | | | | | T | | 0 | 0 | 0 | T |
| 1-6 | | | | | | T | 0 | 0 | 0 | T |
| 2-1 | T | | T | | | | 0 | 0 | 0 | T |
| 2-2 | T | | | T | | | 0 | 0 | 0 | T |
| 2-3 | T | | | | T | | 0 | 0 | 0 | T |
| 2-4 | T | | | | | T | 0 | 0 | 0 | T |
| 2-5 | | T | T | | | | 0 | 0 | 0 | T |
| 2-6 | | T | | T | | | 0 | 0 | 0 | T |
| 2-7 | | T | | | T | | 0 | 0 | 0 | T |
| 2-8 | | T | | | | T | 0 | 0 | 0 | T |
| 2-9 | | | T | | T | | 0 | 0 | 0 | T |
| 2-10 | | | T | | | T | 0 | 0 | 0 | T |
| 2-11 | | | | T | T | | 0 | 0 | 0 | T |
| 2-12 | | | | T | | T | 0 | 0 | 0 | T |
| 3-1 | T | | T | | | | 1 | 1 | 0 | |
| 3-2 | T | | | T | | | 1 | 1 | 0 | |
| 3-3 | T | | | | T | | 1 | 0 | 1 | |
| 3-4 | T | | | | | T | 1 | 0 | 1 | |
| 3-5 | | T | T | | | | 1 | 1 | 0 | |
| 3-6 | | T | | T | | | 1 | 1 | 0 | |
| 3-7 | | T | | | T | | 1 | 0 | 1 | |
| 3-8 | | T | | | | T | 1 | 0 | 1 | |
| 3-9 | | | T | | T | | 0 | 1 | 1 | |
| 3-10 | | | T | | | T | 0 | 1 | 1 | |
| 3-11 | | | | T | T | | 0 | 1 | 1 | |
| 3-12 | | | | T | | T | 0 | 1 | 1 | |
| 4-1 | T | | T | | T | | 0 | 0 | 0 | T |
| 4-2 | T | | T | | | T | 0 | 0 | 0 | T |
| 4-3 | T | | | T | T | | 0 | 0 | 0 | T |
| 4-4 | T | | | T | | T | 0 | 0 | 0 | T |
| 4-5 | | T | T | | T | | 0 | 0 | 0 | T |
| 4-6 | | T | T | | | T | 0 | 0 | 0 | T |
| 4-7 | | T | | T | T | | 0 | 0 | 0 | T |
| 4-8 | | T | | T | | T | 0 | 0 | 0 | T |
| 5-1 | T | | T | | T | | 0 | 0 | 0 | |
| 5-2 | T | | T | | | T | 0 | 0 | 0 | |
| 5-3 | T | | | T | T | | 0 | 0 | 0 | |
| 5-4 | T | | | T | | T | 0 | 0 | 0 | |
| 5-5 | | T | T | | T | | 0 | 0 | 0 | |
| 5-6 | | T | T | | | T | 0 | 0 | 0 | |
| 5-7 | | T | | T | T | | 0 | 0 | 0 | |
| 5-8 | | T | | T | | T | 0 | 0 | 0 | |
| 6-1 | T | | T | | T | | 0 | 1 | 1 | T |
| 6-2 | T | | T | | | T | 0 | 1 | 1 | T |
| 6-3 | T | | | T | T | | 0 | 1 | 1 | T |
| 6-4 | T | | | T | | T | 0 | 1 | 1 | T |
| 6-5 | | T | T | | T | | 0 | 1 | 1 | T |
| 6-6 | | T | T | | | T | 0 | 1 | 1 | T |
| 6-7 | | T | | T | T | | 0 | 1 | 1 | T |
| 6-8 | | T | | T | | T | 0 | 1 | 1 | T |
| 6-9 | T | | T | | T | | 1 | 0 | 1 | T |
| 6-10 | T | | T | | | T | 1 | 0 | 1 | T |
| 6-11 | | T | T | | T | | 1 | 0 | 1 | T |
| 6-12 | | T | T | | | T | 1 | 0 | 1 | T |
| 6-13 | T | | | T | T | | 1 | 0 | 1 | T |
| 6-14 | T | | | T | | T | 1 | 0 | 1 | T |
| 6-15 | | T | | T | T | | 1 | 0 | 1 | T |
| 6-16 | | T | | T | | T | 1 | 0 | 1 | T |
| 6-17 | T | | T | | T | | 1 | 1 | 0 | T |
| 6-18 | T | | T | | T | | 1 | 1 | 0 | T |
| 6-19 | | T | T | | T | | 1 | 1 | 0 | T |
| 6-20 | | T | | T | T | | 1 | 1 | 0 | T |
| 6-21 | T | | T | | | T | 1 | 1 | 0 | T |
| 6-22 | T | | | T | | T | 1 | 1 | 0 | T |
| 6-23 | | T | T | | | T | 1 | 1 | 0 | T |
| 6-24 | | T | | T | | T | 1 | 1 | 0 | T |
| 7-1 | T | | T | | T | | 2 | 2 | 2 | |
| 7-2 | | T | T | | T | | 2 | 2 | 2 | |
| 7-3 | T | | | T | T | | 2 | 2 | 2 | |
| 7-4 | | T | | T | T | | 2 | 2 | 2 | |
| 7-5 | T | | T | | | T | 2 | 2 | 2 | |
| 7-6 | | T | T | | | T | 2 | 2 | 2 | |
| 7-7 | T | | | T | | T | 2 | 2 | 2 | |
| 7-8 | | T | | T | | T | 2 | 2 | 2 | |
| 8-1 | T | | T | | T | | 1 | 1 | 2 | |
| 8-2 | | T | T | | T | | 1 | 1 | 2 | |
| 8-3 | T | | | T | T | | 1 | 1 | 2 | |
| 8-4 | | T | | T | T | | 1 | 1 | 2 | |
| 8-5 | T | | T | | | T | 1 | 1 | 2 | |
| 8-6 | | T | T | | | T | 1 | 1 | 2 | |
| 8-7 | T | | | T | | T | 1 | 1 | 2 | |
| 8-8 | | T | T | | | T | 1 | 1 | 2 | |
| 8-9 | T | | T | | T | | 2 | 1 | 1 | |
| 8-10 | T | | T | | | T | 2 | 1 | 1 | |
| 8-11 | T | | | T | T | | 2 | 1 | 1 | |
| 8-12 | T | | | T | | T | 2 | 1 | 1 | |
| 8-13 | | T | T | | T | | 2 | 1 | 1 | |
| 8-14 | | T | T | | | T | 2 | 1 | 1 | |
| 8-15 | | T | | T | T | | 2 | 1 | 1 | |
| 8-16 | | T | | T | | T | 2 | 1 | 1 | |
| 8-17 | T | | T | | T | | 1 | 2 | 1 | |
| 8-18 | T | | T | | | T | 1 | 2 | 1 | |
| 8-19 | | T | T | | T | | 1 | 2 | 1 | |
| 8-20 | | T | T | | | T | 1 | 2 | 1 | |
| 8-21 | T | | | T | T | | 1 | 2 | 1 | |
| 8-22 | T | | | T | | T | 1 | 2 | 1 | |
| 8-23 | | T | | T | T | | 1 | 2 | 1 | |
| 8-24 | | T | | T | | T | 1 | 2 | 1 | |

The information contained in Table 9 is sufficient to construct a polygonal surface. In exemplary embodiments of the present invention, to make the data presented in Table 9 more convenient for implementation in various programming languages, three new Boolean variables can be defined, for example, as follows:
εᵢ=(eᵢ₋∥eᵢ₊)∥(\overline{ε}ᵢ=2)
εⱼ=(eⱼ₋∥eⱼ₊)μ(\overline{ε}ⱼ=2)
εₖ=(eₖ₋∥eₖ₊)∥(\overline{ε}ₖ=2)

to replace \overline{ε}ᵢ, \overline{ε}ⱼ, \overline{ε}ₖ. Implementing this technique, for example, results in Table 10.

TABLE 10

| | fᵢ₋ | fᵢ₊ | fⱼ₋ | fⱼ₊ | fₖ₋ | fₖ₊ | εᵢ | εⱼ | εₖ | ε | loop |
|---|---|---|---|---|---|---|---|---|---|---|---|
| 1-1 | T | | | | | | T | | | T | CGHD |
| 1-2 | | T | | | | | T | | | T | CDHG |
| 1-3 | | | T | | | | | T | | T | ABFE |
| 1-4 | | | | T | | | | T | | T | AEBF |
| 1-5 | | | | | T | | | | T | T | IJLK |
| 1-6 | | | | | | T | | | T | T | IKLJ |
| 2-1 | T | | T | | | | T | T | | T | BFHD |
| 2-2 | T | | | T | | | T | T | | T | BCGF |
| 2-3 | T | | | | T | | T | | T | T | CLKD |
| 2-4 | T | | | | | T | T | | T | T | GHKL |
| 2-5 | | T | T | | | | T | T | | T | ADHE |
| 2-6 | | T | | T | | | T | T | | T | AEGC |
| 2-7 | | T | | | T | | T | | T | T | CDIJ |
| 2-8 | | T | | | | T | T | | T | T | GJIH |
| 2-9 | | | T | | T | | | T | T | T | ABKI |
| 2-10 | | | T | | | T | | T | T | T | EIKF |
| 2-11 | | | | T | T | | | T | T | T | AJLB |
| 2-12 | | | | T | | T | | T | T | T | EFLJ |
| 3-1 | T | | T | | | | | | | | ACGE |
| 3-2 | T | | | T | | | | | | | AEHD |
| 3-3 | T | | | | T | | | | | | GHIJ |
| 3-4 | T | | | | | T | | | | | CJID |
| 3-5 | | T | T | | | | | | | | BFGC |
| 3-6 | | T | | T | | | | | | | BDHF |
| 3-7 | | T | | | T | | | | | | GLKH |
| 3-8 | | T | | | | T | | | | | CDKL |
| 3-9 | | | T | | T | | | | | | EJLF |
| 3-10 | | | T | | | T | | | | | ABLJ |
| 3-11 | | | | T | T | | | | | | EFKI |
| 3-12 | | | | T | | T | | | | | AIKB |
| 4-1 | T | | T | | T | | T | T | T | T | BKD |
| 4-2 | T | | T | | | T | T | T | T | T | FHK |
| 4-3 | T | | | T | T | | T | T | T | T | BCL |
| 4-4 | T | | | T | | T | T | T | T | T | FLG |
| 4-5 | | T | T | | T | | T | T | T | T | ADI |
| 4-6 | | T | T | | | T | T | T | T | T | EIH |
| 4-7 | | T | | T | T | | T | T | T | T | AJC |
| 4-8 | | T | | T | | T | T | T | T | T | EGJ |
| 5-1 | T | | T | | T | | | | | | EJG |
| 5-2 | T | | T | | | T | | | | | ACJ |
| 5-3 | T | | | T | | T | | | | | EHI |
| 5-4 | T | | | T | | T | | | | | AID |
| 5-5 | | T | T | | T | | | | | | FGL |
| 5-6 | | T | T | | | T | | | | | BLC |
| 5-7 | | T | | T | T | | | | | | FKH |
| 5-8 | | T | | T | | T | | | | | BDK |
| 6-1 | T | | T | | T | | T | | | T | CLFHD |
| 6-2 | T | | T | | | T | T | | | T | BLGHD |
| 6-3 | T | | | T | T | | T | | | T | CGFKD |
| 6-4 | T | | | T | | T | T | | | T | BCGHK |
| 6-5 | | T | T | | T | | T | | | T | CDHEJ |
| 6-6 | | T | T | | | T | T | | | T | ADHGJ |
| 6-7 | | T | | T | T | | T | | | T | CDIEG |
| 6-8 | | T | | T | | T | T | | | T | AIHGC |
| 6-9 | T | | T | | T | | | T | | T | ABFHI |
| 6-10 | T | | T | | | T | | T | | T | BFEID |
| 6-11 | | T | T | | T | | | T | | T | ABKHE |
| 6-12 | | T | T | | | T | | T | | T | ADKFE |
| 6-13 | T | | | T | T | | | T | | T | AJGFB |
| 6-14 | T | | | T | | T | | T | | T | BCJEF |
| 6-15 | | T | | T | T | | | T | | T | AEGLB |
| 6-16 | | T | | T | | T | | T | | T | AEFLC |
| 6-17 | T | | T | | T | | | | T | T | ACLKI |
| 6-18 | T | | | T | T | | | | T | T | AJLKD |
| 6-19 | | T | T | | T | | | | T | T | BKIJC |
| 6-20 | | T | | T | T | | | | T | T | BDIJL |
| 6-21 | T | | T | | | T | | | T | T | EIKLG |
| 6-22 | T | | | T | | T | | | T | T | EHKLJ |
| 6-23 | | T | T | | | T | | | T | T | FGJIK |
| 6-24 | | T | | T | | T | | | T | T | FLJIH |
| 7-1 | T | | T | | T | | T | T | T | | ACLFHI |
| 7-2 | | T | T | | T | | T | T | T | | BKHEJC |
| 7-3 | T | | | T | T | | T | T | T | | AJGFKD |
| 7-4 | | T | | T | T | | T | T | T | | BDIEGL |
| 7-5 | T | | T | | | T | T | T | T | | BLGEID |
| 7-6 | | T | T | | | T | T | T | T | | ADKFGJ |
| 7-7 | T | | | T | | T | T | T | T | | BCJEHK |
| 7-8 | | T | | T | | T | T | T | T | | AIHFLC |
| 8-1 | T | | T | | T | | | | T | | FHIJL |
| 8-2 | | T | T | | T | | | | T | | EJLKH |
| 8-3 | T | | | T | T | | | | T | | FKIJG |
| 8-4 | | T | | T | T | | | | T | | EGLKI |
| 8-5 | T | | T | | | T | | | T | | BLJID |
| 8-6 | | T | T | | | T | | | T | | ADKLJ |
| 8-7 | T | | | T | | T | | | T | | BCJIK |
| 8-8 | | T | T | | | T | | | T | | AIKLC |
| 8-9 | T | | T | | T | | T | | | | ACGHI |
| 8-10 | T | | T | | | T | T | | | | CGEID |
| 8-11 | T | | | T | T | | T | | | | AJGHD |
| 8-12 | T | | | T | | T | T | | | | CJEHD |
| 8-13 | | T | T | | T | | T | | | | BKHGC |
| 8-14 | | T | T | | | T | T | | | | CDKFG |
| 8-15 | | T | | T | T | | T | | | | BDHGL |
| 8-16 | | T | | T | | T | T | | | | CDHFL |
| 8-17 | T | | T | | T | | | T | | | ACLFE |
| 8-18 | T | | T | | | T | | T | | | ABLGE |
| 8-19 | | T | T | | T | | | T | | | BFEJC |
| 8-20 | | T | T | | | T | | T | | | ABFGJ |
| 8-21 | T | | | T | T | | | T | | | AEFKD |
| 8-22 | T | | | T | | T | | T | | | AEHKB |
| 8-23 | | T | | T | T | | | T | | | BDIEF |
| 8-24 | | T | | T | | T | | T | | | AIHFB |

The last column in Table 10 defines an exemplary surface shape corresponding to each case to divide the voxel. Appendix II provides a pictorial description of this surface for every case listed in Table 10. In Appendix II polygons and triangles are specified using the right hand rule to indicate the normal direction. The direction of the normal vector to a triangle points away from—or out of—the posited boundary of the object. Thus, for example, in Case 1-1 of Appendix II, because the object is to the left of the depicted voxel (the −i direction) the portion of the voxel to the left of the polygonal surface is considered within the object boundary. The normal thus points away from the object.

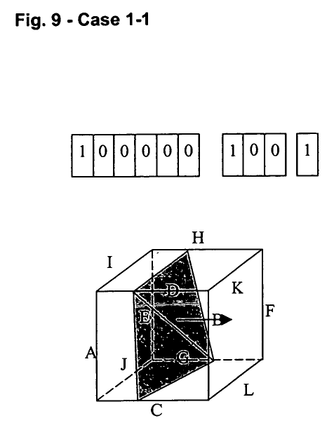

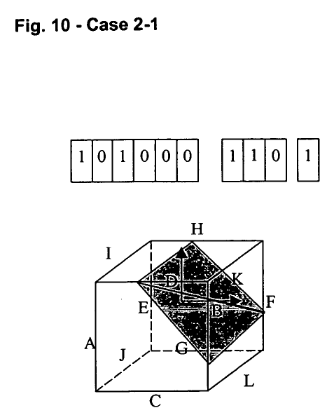

Using the exemplary ten Boolean variables of Table 10, how the partial surface within the surface voxel can be configured can be determined. For example, for case 1-1 in FIG. 9, as ε is TRUE, and ƒᵢ₋ is TRUE, the normal of the surface within the voxel is known to only have i+ direction element and to cut those edges of the voxel that are parallel to the i direction. FIG. 9 gives one exemplary solution how triangles can be used, for example, to triangulate the partial surface. Another example, that of case 2-1 in Table 9, in FIG. 10, as ε, ƒᵢ₋ and ƒⱼ₋ are TRUE, the normal of the surface within the voxel is known to have an i+ direction element and a j+ direction element, and the left and bottom faces are shared with an inside voxel, which cannot be cut. So the top and right faces are cut, as shown in FIG. 10.

4. Post Processing

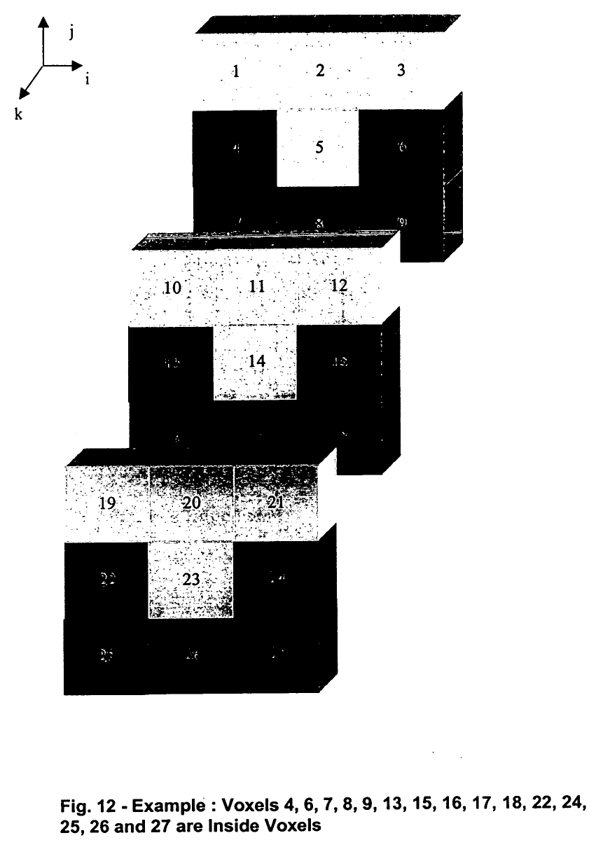

For a surface voxel, if both ƒᵢ₋ and ƒᵢ₊ are TRUE, or both ƒⱼ₋ and ƒⱼ₊ are TRUE, or, both ƒₖ₋ and ƒₖ₊ are TRUE, the voxel is considered as an ambiguous voxel, as described above in connection with FIG. 2. This means that according the currently available information for that voxel, it is impossible to determine how the surface should go through the voxel. For this type of voxel, post-processing can, for example, provide a solution. FIG. 12 depicts an exemplary case requiring post processing, as voxels 5, 14 and 23 are ambiguous (there is no way to divide these voxels with a polygonal surface so that part of the voxel is “inside” and part is “outside” the object). Both sides (left and right) would be expected to be on the “inside” of the surface given the “inside” neighbors on each side. This is an example of a groove structure as described above in connection with FIG. 2.

Table 11 provides exemplary values of the Boolean variables after steps 1, 2, 3 and 4 described above have been performed. In this example voxels 5, 14, 23, 2, 11 and 20 to be post-processed.

TABLE 11

| | fᵢ₋ | fᵢ₊ | fⱼ₋ | fⱼ₊ | fₖ₋ | fₖ₊ | εᵢ | εⱼ | εₖ | ε |
|---|---|---|---|---|---|---|---|---|---|---|
| 1 | | | TRUE | | | | | TRUE | | TRUE |
| 3 | | | TRUE | | | | | TRUE | | TRUE |
| 10 | | | TRUE | | | | | TRUE | | TRUE |
| 12 | | | TRUE | | | | | TRUE | | TRUE |
| 19 | | | TRUE | | | | | TRUE | | TRUE |
| 21 | | | TRUE | | | | | TRUE | | TRUE |
| 5 | TRUE | TRUE | TRUE | | | | TRUE | TRUE | | TRUE |
| 14 | TRUE | TRUE | TRUE | | | | TRUE | TRUE | | TRUE |
| 23 | TRUE | TRUE | TRUE | | | | TRUE | TRUE | | TRUE |
| 2 | TRUE | TRUE | TRUE | | | | | | | |
| 11 | TRUE | TRUE | TRUE | | | | | | | |
| 20 | TRUE | TRUE | TRUE | | | | | | | |

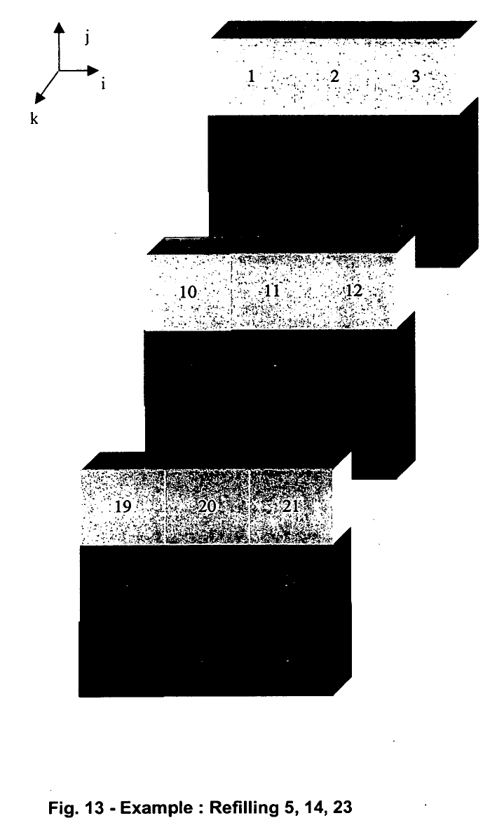

In exemplary embodiments of the present invention post-processing can be implemented in two ways. A first method, for example, is refilling, which changes an ambiguous voxel to be an inside voxel. FIG. 13 shows what happens when voxels 5, 14, and 23 are marked as inside voxels. No ambiguous voxels any longer appear. In general, in implementing this functionality those ambiguous voxels whose ε value is TRUE are refilled. In the example depicted in FIG. 12, however, simply refilling voxels 2, 11, 20 will not solve the problem. When a voxel is refilled, a small 5×5×5 volume around the refilled voxel must be recalculated, because the refilled voxel will affect its 26 neighbors' variable values.

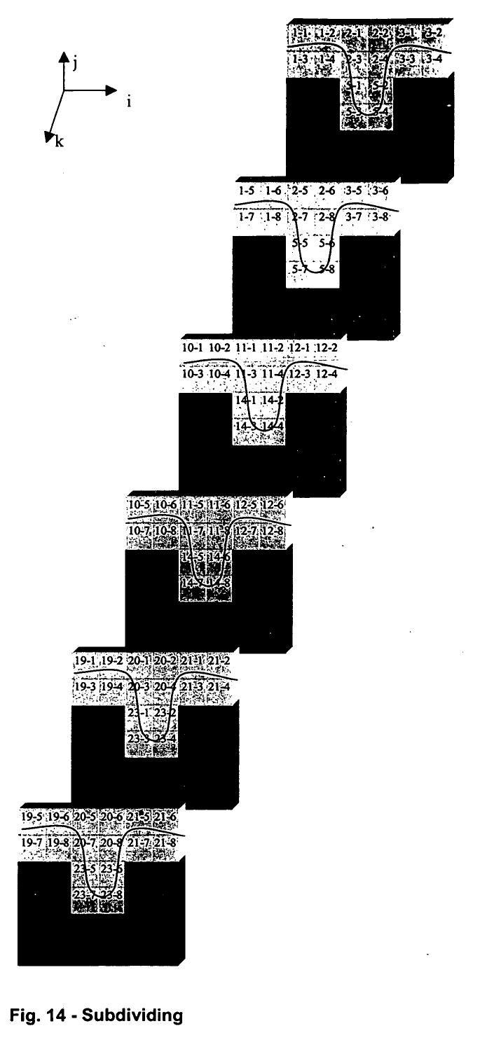

Another exemplary method is subdivision, as introduced above in a 2D case with reference to FIG. 2, in particular voxels 230 being subdivided to yield voxels 241 and 261. The basic idea of subdivision is that every voxel of a 3×3×3 volume around an ambiguous voxel can be divided into eight equal parts. FIG. 14 shows an exemplary subdivision of the example voxels of FIG. 12. Every sub-voxel has the same intensity value as did its “parent.” If an original voxel is an outside voxel, then all of its eight sub-voxel children are outside sub-voxels. After subdividing, an interesting phenomenon can be seen. Ambiguous voxel 14 in FIG. 12 can be, for example, divided into 8 parts, i.e., 14-1, 14-2, 14-3, 14-4, 14-5, 14-6, 14-7 and 14-8, as shown in FIG. 14. When the new 6×6×6 volume is processed and the e values for the voxel 14-1 are computed, only three of its direct neighbors, i.e., 5-5, 11-3 and 13-2, should be considered and the other three, 14-2, 14-3 and 14-5, are its “brothers.” Moreover, voxel 14-1 will never get shared information about i+, j+, and k+ from its face neighbors and edge neighbors. This can insure, for example, that no ambiguous voxel will appear after subdividing.

For example, according to equation 2, ƒᵢ₊ of voxel 14-1 can be determined by eᵢ₊(14-1), eᵢ₊(14-3), eᵢ₊(14-5), eᵢ₊(5-5), eᵢ₊(11-3), eᵢ₊(5-7), eᵢ₊(2-7), eᵢ₊(11-7), eᵢ₊(14-7). All of the above values are always FALSE, because the right direct neighbors of them are their “brothers” (i.e., “descended” from the same original voxel), and thus have the same intensity values as they do. So the ƒᵢ₊ of voxel 14-1 will always be FALSE.

Table 12 below lists the results of subdivision for voxel 14, shown in FIG. 14. None of the eight children of 14 are any longer ambiguous.

TABLE 12

| | fᵢ₋ | fᵢ₊ | fⱼ₋ | fⱼ₊ | fₖ₋ | fₖ₊ | εᵢ | εⱼ | εₖ | ε |
|---|---|---|---|---|---|---|---|---|---|---|
| 14-1 | TRUE | | | | | | TRUE | | | TRUE |
| 14-2 | | TRUE | | | | | TRUE | | | TRUE |
| 14-3 | TRUE | | TRUE | | | | TRUE | TRUE | | TRUE |
| 14-4 | | TRUE | TRUE | | | | TRUE | TRUE | | TRUE |
| 14-5 | TRUE | | | | | | TRUE | | | TRUE |
| 14-6 | | TRUE | | | | | TRUE | | | TRUE |
| 14-7 | TRUE | | TRUE | | | | TRUE | TRUE | | TRUE |
| 14-8 | | TRUE | TRUE | | | | TRUE | TRUE | | TRUE |

5. Vertex Position

The choice of which geometric point within an edge to place the vertex of the polygonal surface can be achieved in various ways, such as, for example, always placing the point at the mid-point of the edge, or adjusting it along the edge to maximize the smoothness of the resulting surface. Where the data available to an implementation includes not only a segmentation into ‘inside’ and ‘outside’ elements, but the actual values at each element and the threshold level used to so classify them (if this was the basis for the classification), in an exemplary embodiment of the present invention the vertex can be placed according to interpolated values of the physical quantity represented by the element values ƒ as samples, and the threshold T above which an element is classified as ‘inside’. (The following description also covers also cases where ‘inside’ means ‘below the threshold’, by reversing the signs of ƒ and T). Specifically, these points can be placed, for example, as follows.

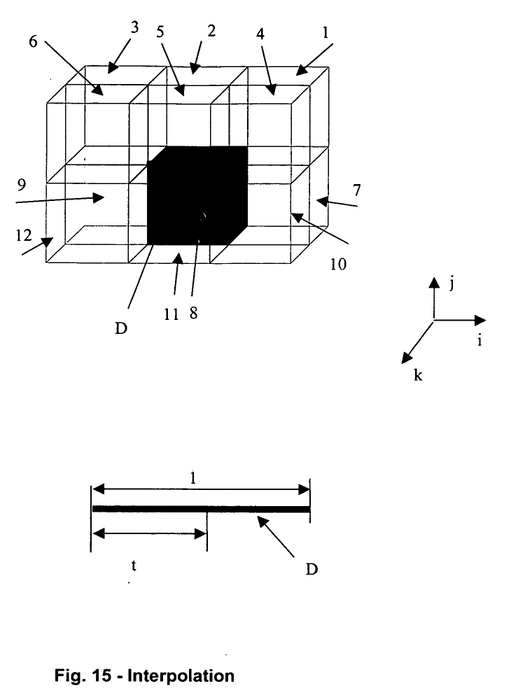

As shown for example in FIG. 15, a point along edge D of surface voxel 8 needs to be chosen. In the depicted example voxels 2, 5 and 11 are also surface voxels which share an edge with voxel 8. On the assumption that the physical value at an element approximates an average over that element of a scanned physical quantity most of whose values are either near some F_{dense}>T, or near some F_{light}<T, a high value suggests that more of an element should be inside the above-T region (even though on average, it is below), so the dividing surface should be nearer to the faces on which the element meets the outside. These considerations can be reflected, for example, in various explicit formulae which give weighted influence to the values of the elements that meet the edge. A selection of such formulae for the case shown in FIG. 15, of an edge in the i direction and shared by outside elements is described.

It is noted that the following exemplary equations have advantages where data is given in a binary way (Inside or Outside for each element, in the input, rather than found from scalar values) and no natural threshold T is available. It is further noted that

$$\begin{matrix}{t}_{1} = \frac{( {f}_{9} - {f}_{8} )}{( {f}_{9} - {f}_{7} )} & ( Equation 7 ) \\ {t}_{2} = \frac{( {f}_{12} - {f}_{11} )}{( {f}_{12} - {f}_{10} )} & ( Equation 8 ) \\ {t}_{3} = \frac{( {f}_{6} - {f}_{5} )}{( {f}_{6} - {f}_{4} )} & ( Equation 9 ) \\ {t}_{4} = \frac{( {f}_{3} - {f}_{2} )}{( {f}_{3} - {f}_{1} )} & ( Equation 10 ) \\ t = \frac{( {t}_{1} + {t}_{2} + {t}_{3} + {t}_{4} )}{4} & ( Equation 11 )\end{matrix}$$

four equations are not used for every interpolation. If tᵢ≦0(i=1, 2, 3, 4), as it is known that the surface must be within the outside voxel, such value may move the surface into an inside voxel. Such a value will thus never be used to compute an interpolation value. The final t can be, for example, the other values' average value.

Another method of interpolation is, for example, using a threshold T to compute an interpolation value. Before doing that the inside neighbors must be found. For the example depicted in FIG. 15, assuming voxels 3, 6, 9 and 12 are inside voxels, the interpolation can be, for example, written as:

$$\begin{matrix}{t}_{1} = \frac{( {f}_{9} - T )}{( {f}_{9} - {f}_{8} )} & ( Equation 12 ) \\ {t}_{2} = \frac{( {f}_{12} - T )}{( {f}_{12} - {f}_{11} )} & ( Equation 13 ) \\ {t}_{3} = \frac{( {f}_{3} - T )}{( {f}_{3} - {f}_{2} )} & ( Equation 14 ) \\ {t}_{1} = \frac{( {f}_{6} - T )}{( {f}_{6} - {f}_{5} )} & ( Equation 15 ) \\ t = \frac{( {t}_{1} + {t}_{2} + {t}_{3} + {t}_{4} )}{4} & ( Equation 16 )\end{matrix}$$

It is thus noted that every interpolation does not require the use of four equations. If tᵢ≦0(i=1, 2, 3, 4), then it is known that the surface must be within the outside voxel, such value may move the surface into an inside voxel. Such value will thus never be used to compute the interpolation value. The final t can then be, for example, the other values' average value.

As noted above, every edge is divided into two edges when subdivision is implemented. If all four of the voxels sharing an edge are ambiguous voxels, there may be two intersecting point along that edge. For all other cases there are one and only one possible intersecting points. For example, in FIG. 12, the edge C of voxel 11 has two intersecting points with the surface (again, refer to FIG. 11 for the edge naming nomenclature used herein). After subdividing, in FIG. 14, the edge C of voxel 11 is divided into two parts—the edges C of each of voxel 11-7 and voxel 11-8. In exemplary embodiments of the present invention those two intersecting points can be computed according to the above described method. But for edge A of voxel 11, because voxel 10 is not an ambiguous voxel, there is only one intersecting point. When voxel 10 is processed, one intersecting point along edge B of voxel 10 can be computed. When voxel 11 is processed, which should be subdivided as shown in FIG. 14, another intersecting point along edge A of voxel 11-7 can be computed. These two points are not the same, but there is only one intersecting point along that edge. If the surface is permitted to intersect such edge two times, there could lots of holes in the result. There are a few methods which can be used, for example, to process the two intersecting points into one. The first, for example, is to compute an average point. The second, for example, is to only keep the computation from subdivision. A final method, for example, is to only keep the computation from non-subdivision. Thus, the last one is implemented in preferred exemplary embodiments of the present invention, as it can, for example, maintain the smoothness of the surface. The curve in FIG. 14 shows the results of implementing this last method.

Exemplary Surfaces

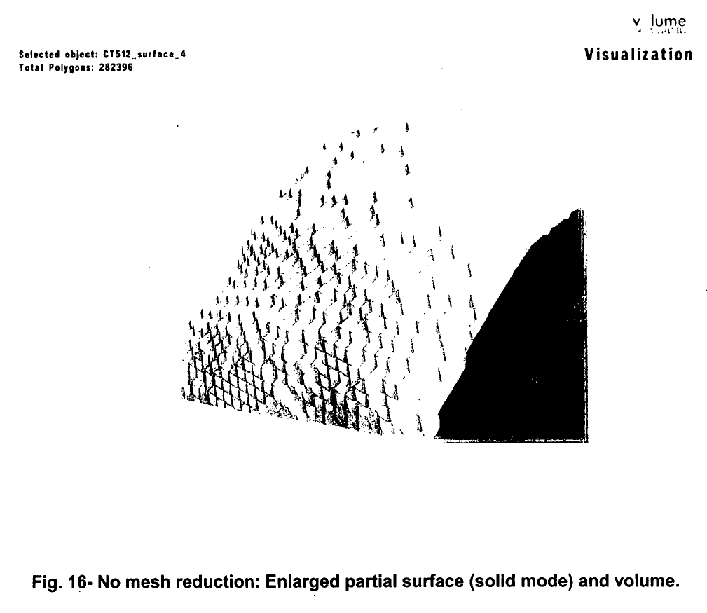

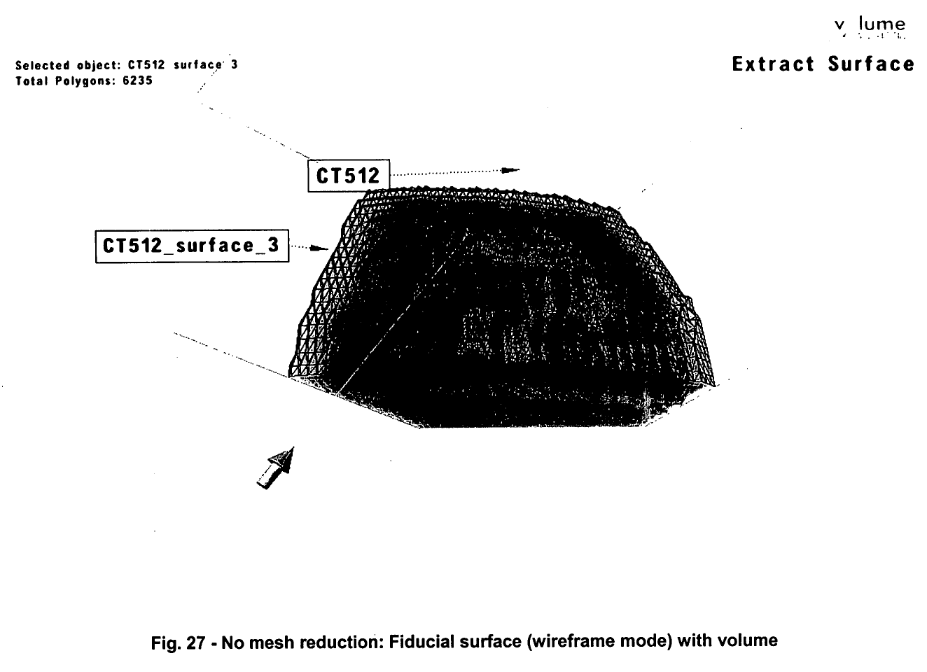

FIGS. 16-41 depict various exemplary surfaces created according to various exemplary embodiments of the present invention.

FIGS. 16-29 depict exemplary surfaces generated without any mesh reduction. The surfaces are shown in exemplary screen shots of an exemplary embodiment of the present invention in a 3D interactive data display system, in this case a Dextroscope™ running RadioDexter™ software, both available form Volume Interactions Pte Ltd of Singapore. Thus the polygon count provided in the upper left of each depicted surface in FIGS. 16-29 is high.

FIG. 16 depicts an enlarged partial surface (solid mode) and the associated volume.

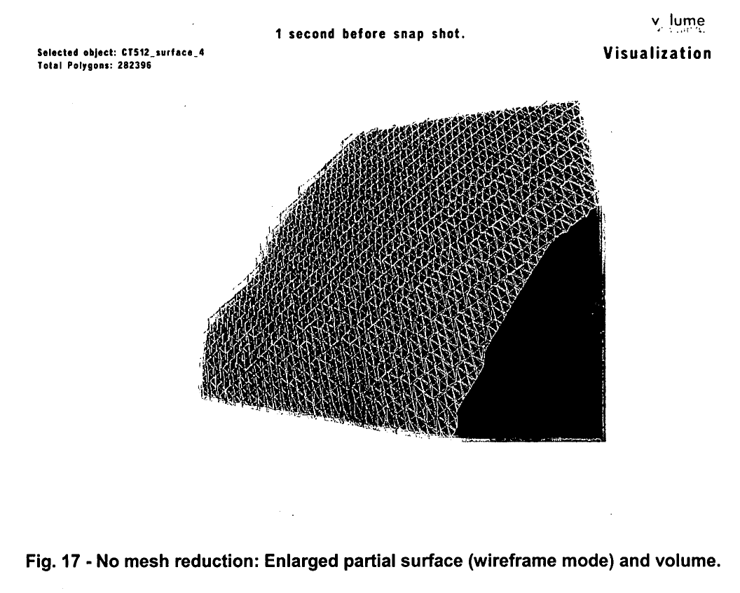

FIG. 17 depicts the enlarged partial surface of FIG. 16 in wireframe mode.

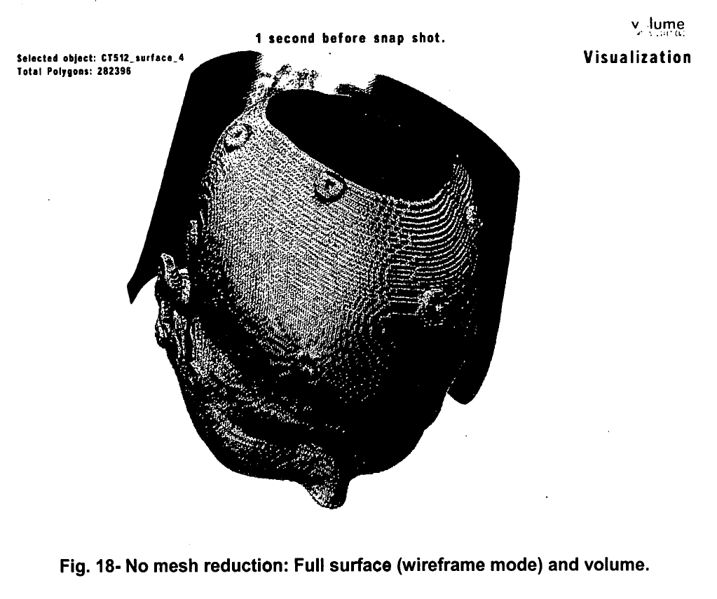

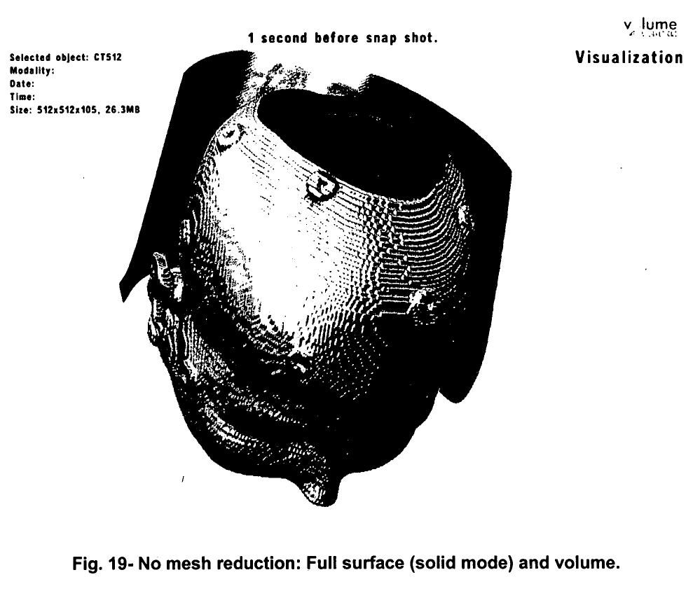

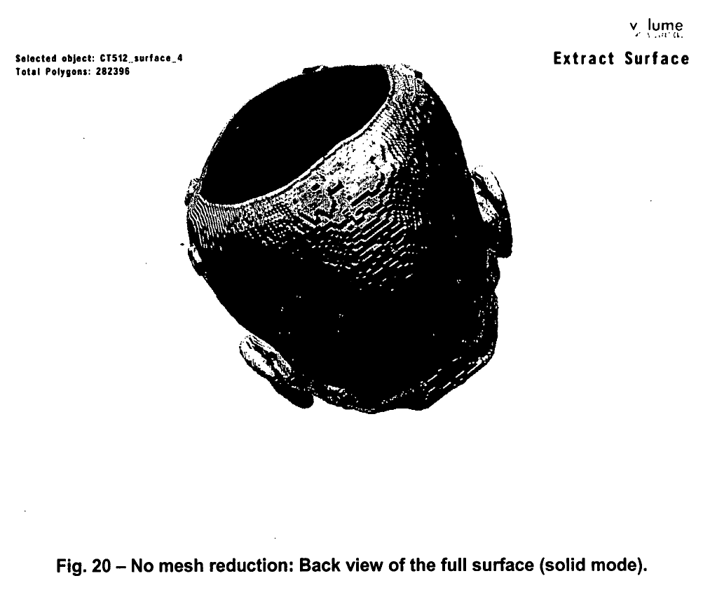

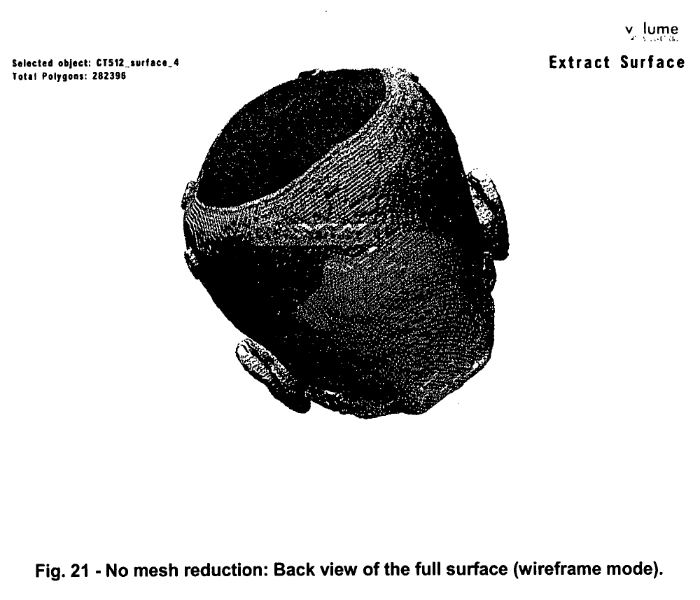

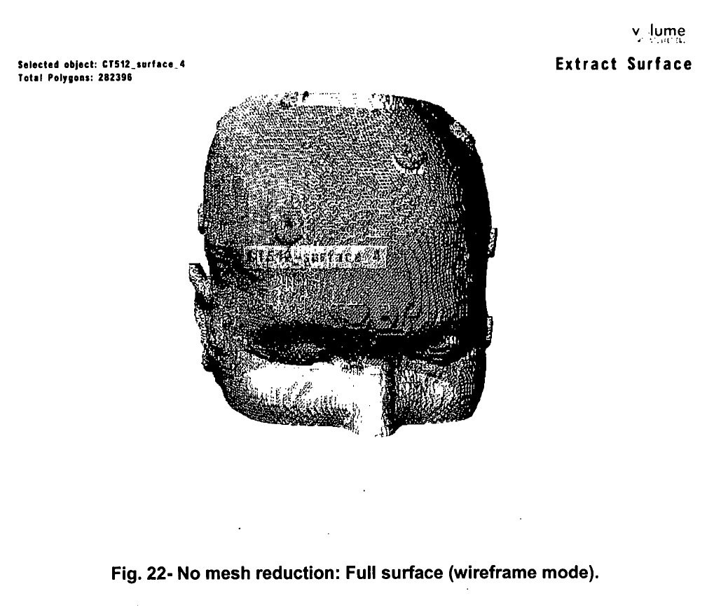

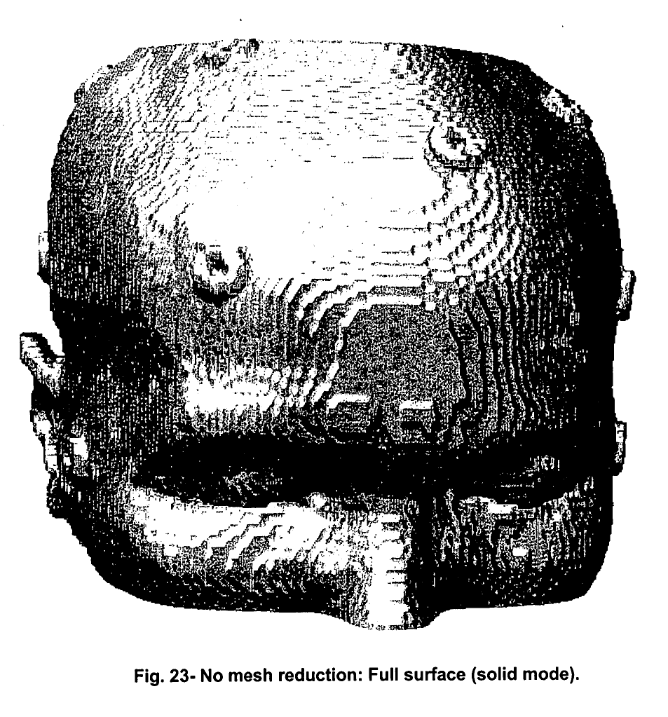

FIG. 18 depicts a full surface (solid mode) and the associated volume. FIG. 19 depicts the surface of FIG. 17 in wireframe mode. FIG. 20 depicts a back view of the full surface of FIG. 18 (solid mode). FIG. 21 depicts the surface of FIG. 20 in wireframe mode. FIG. 22 depicts a portion of the front of the surface of FIG. 20 in wireframe mode and in a full frontal view, and FIG. 23 is the solid mode rendering thereof.

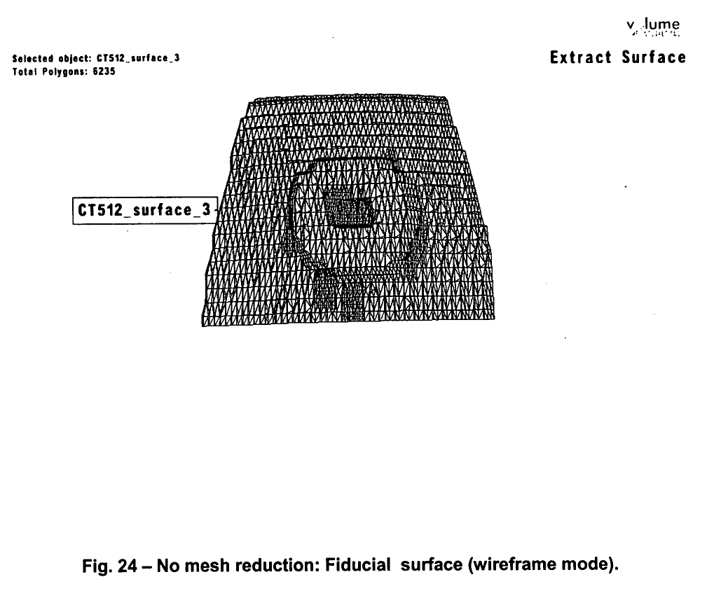

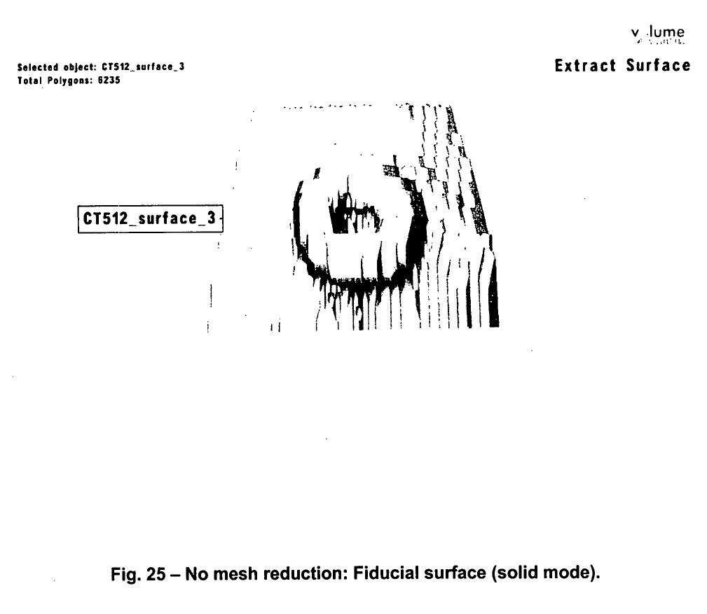

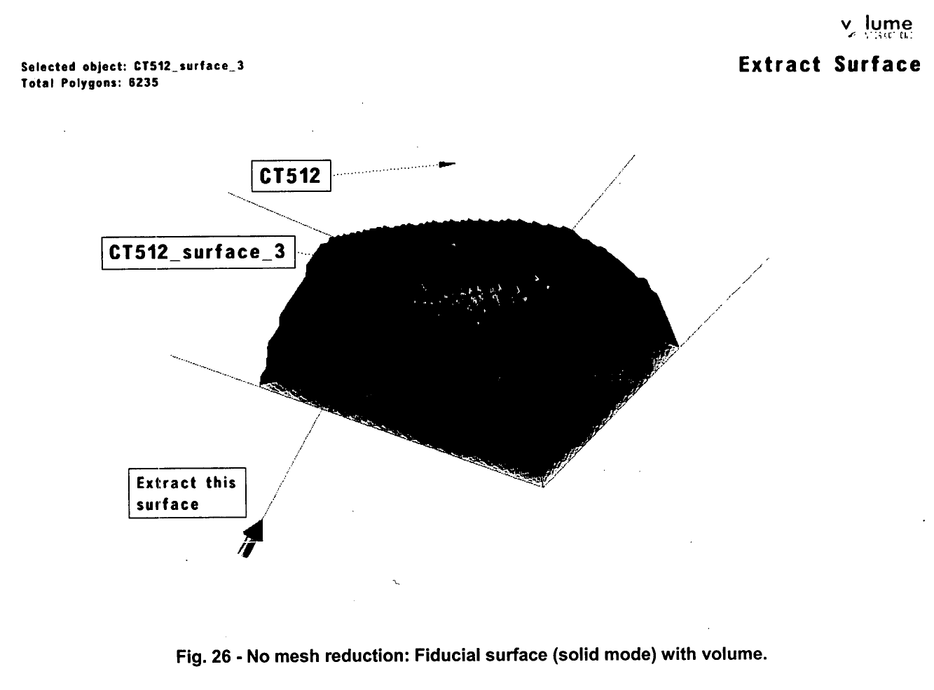

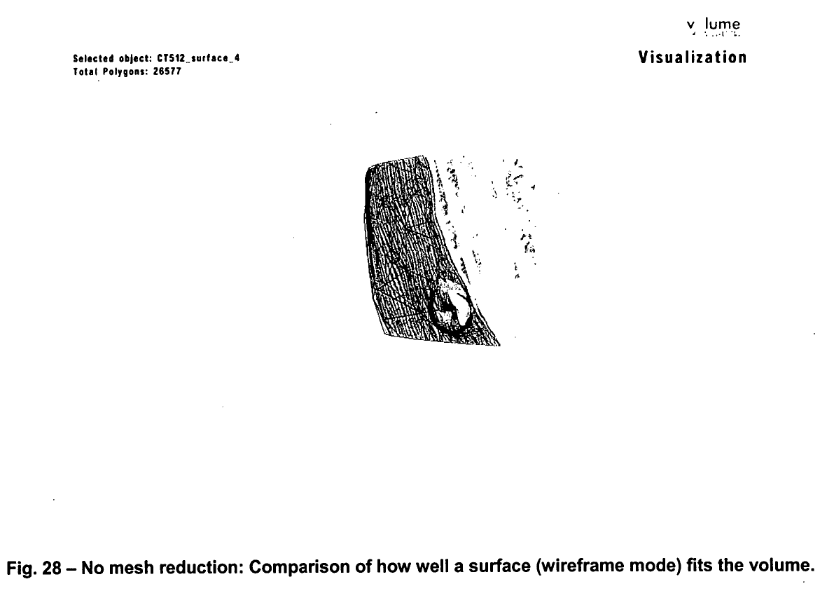

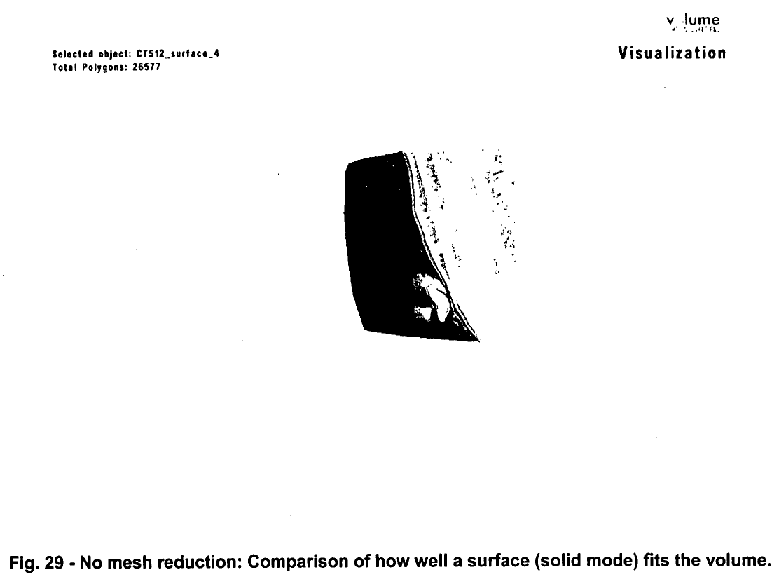

FIG. 24 depicts a fiducial surface (many are visible in FIG. 23, etc.) in wire frame mode, and FIG. 25 the same surface in solid mode. FIG. 26 depicts the same fiducial surface in solid mode with a portion of the associated volume (segmented object from the scan data). FIG. 28 superimposes a wireframe mode mesh of an exemplary surface with a portion of the original input volume for comparison. In exemplary embodiments of the present invention, for a suitable chosen threshold, either sparing or liberal, and a suitable implementation of the methods of the present invention, the mesh surfaces generated can be topologically quite correct. This is illustrated below in connection with volume measurements as described in connection with Table 13. FIG. 29 shows the same comparison in solid mode.

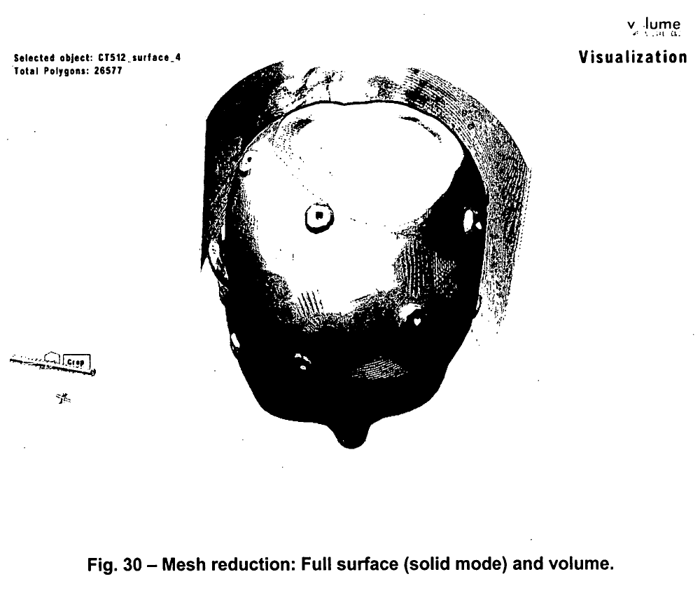

FIGS. 30-38 depict exemplary surfaces generated with a mesh reduction algorithm, as described below. Thus, the total polygon count is approximately one-third to one-tenth that of the original mesh surfaces as seen in the top left of the figures.

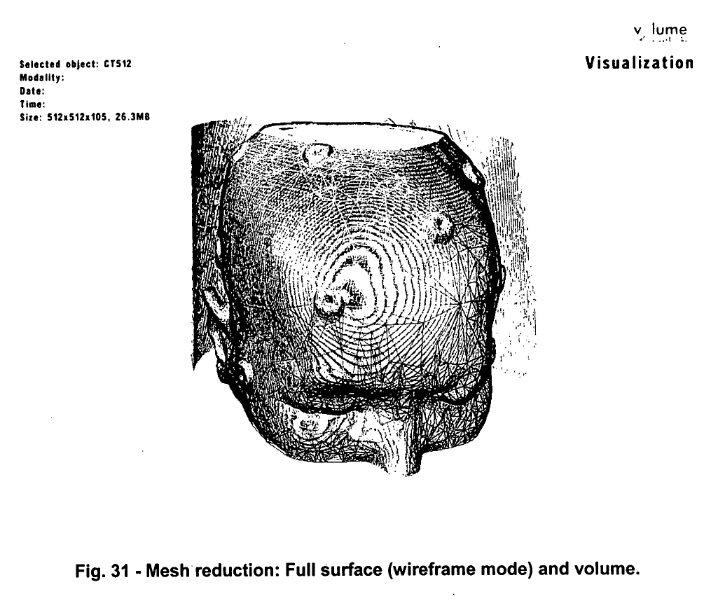

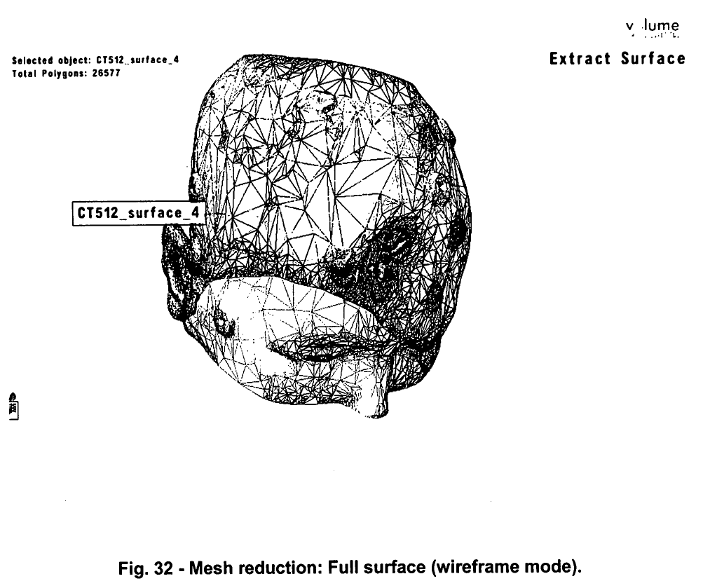

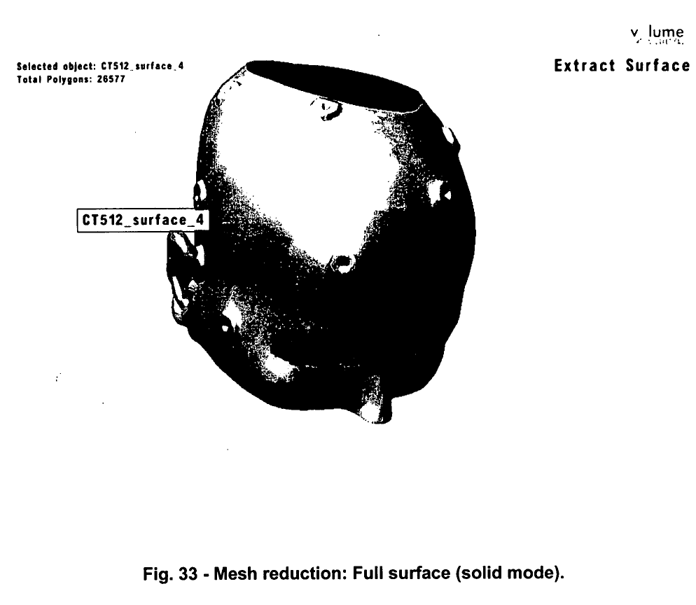

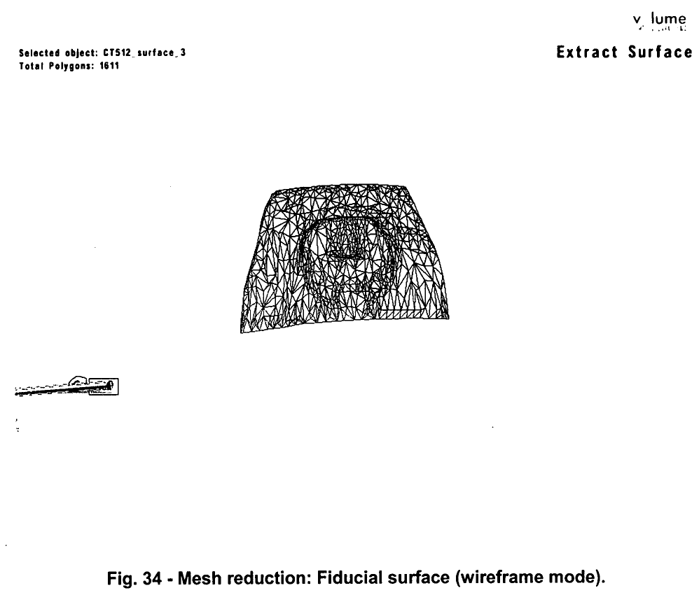

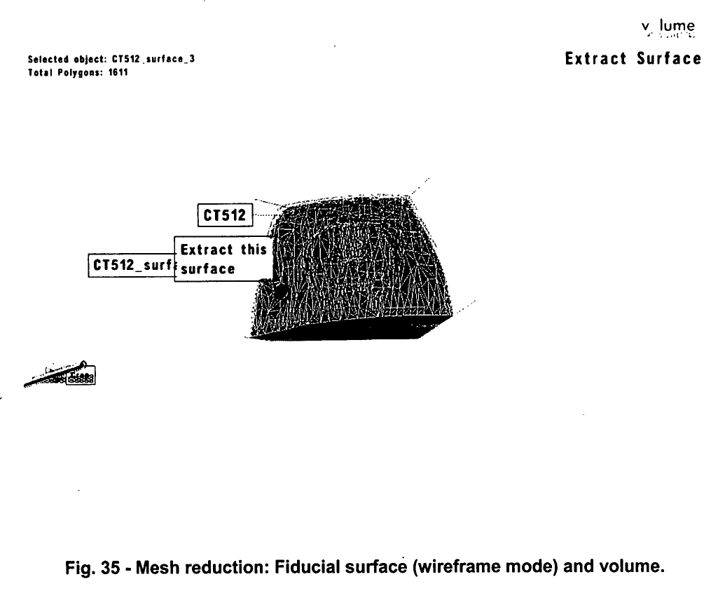

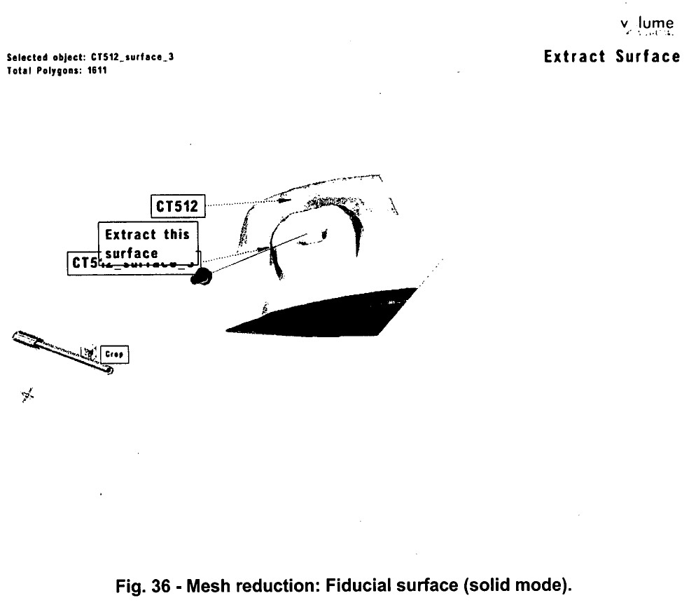

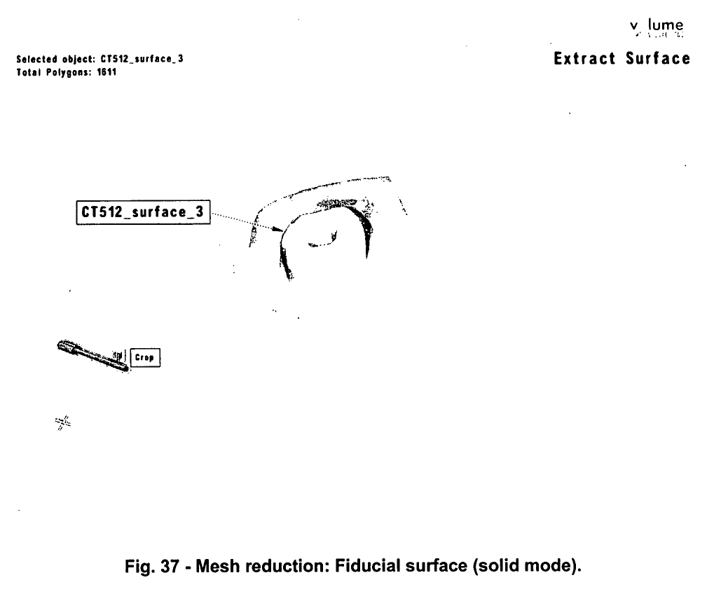

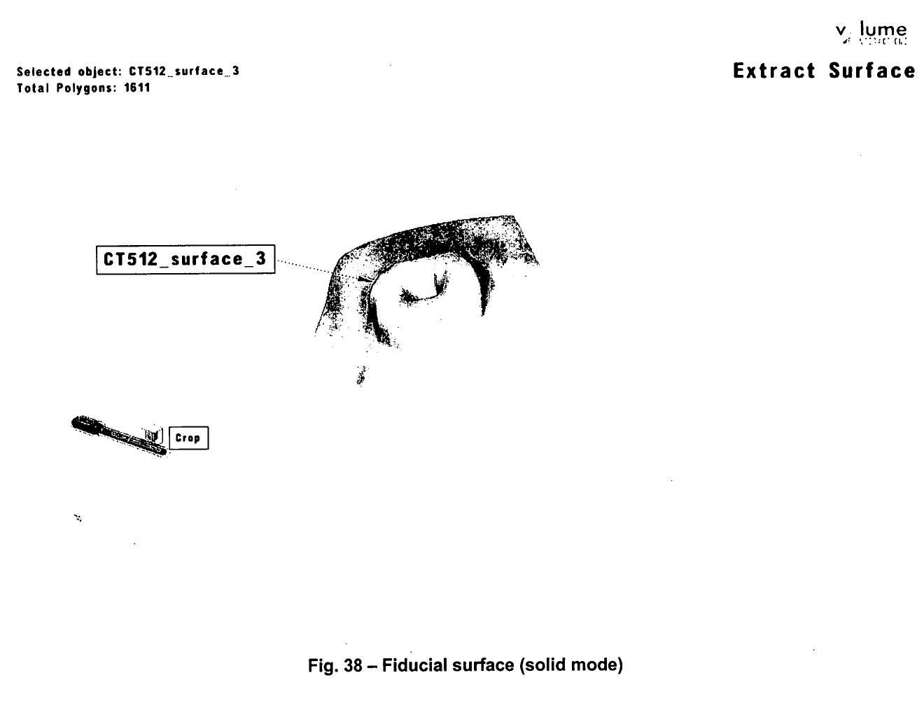

FIG. 30 depicts the surface of FIG. 22 in a solid mode rendering and with a view of the forehead. FIG. 31 is a similar view as that of FIG. 22, but notice the great reduction in polygons. FIG. 32 is a very similar view of the same surface as depicted in FIG. 22, but the polygon count has been reduced from 282,396 to 26,577, an amount greater than 90%. FIG. 33 is a solid mode rendering of the surface of FIG. 32. FIG. 34 is a wireframe mode rendering of the fiducial surface of FIG. 24, with a reduction in the number of polygons from 6235 to 1611. FIGS. 35 and 36 depict wireframe and solid mode renderings of this fiducial surface juxtaposed with the original volume data. FIG. 37 is a solid mode rendering of the fiducial surface of FIG. 34, and FIG. 38 is a magnified, or zoomed version of FIG. 37.

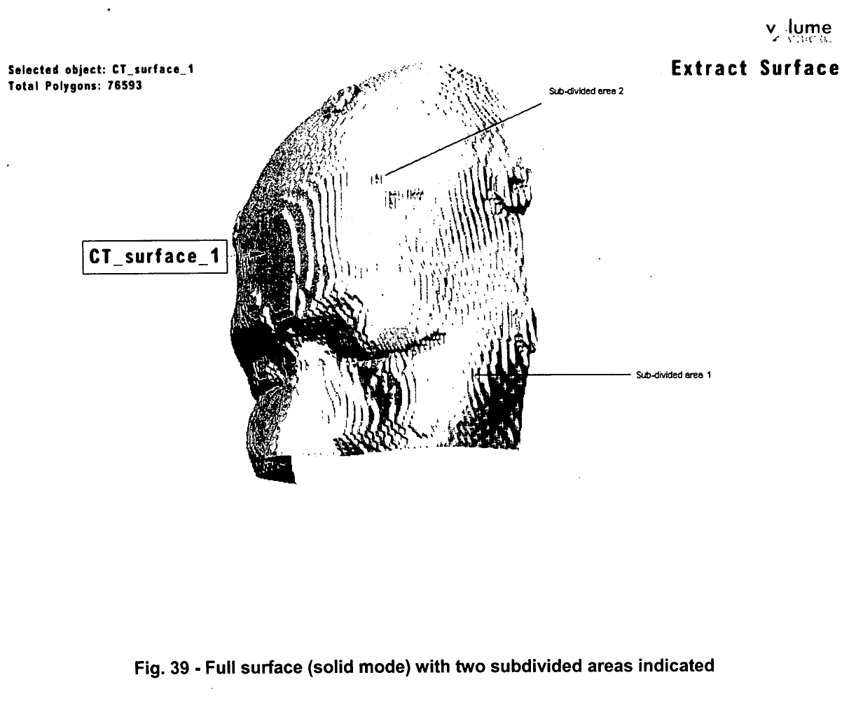

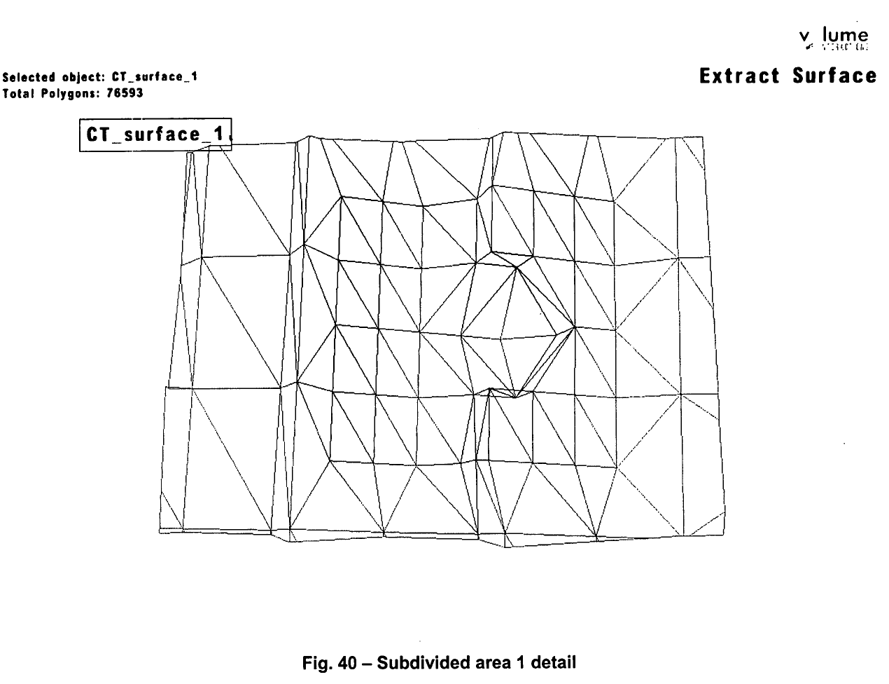

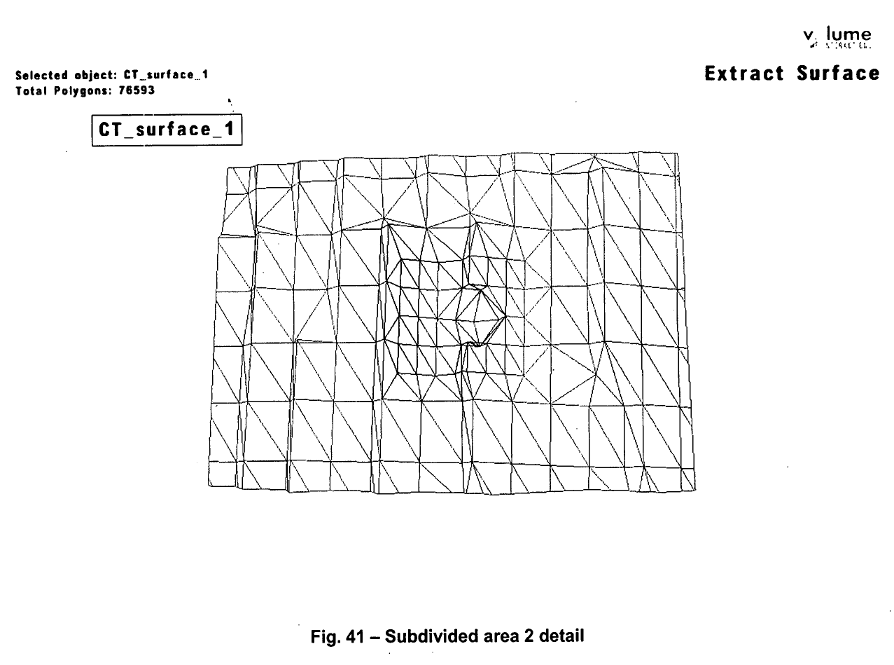

FIGS. 39-41 illustrate subdivision. FIG. 39 depicts a full surface in solid mode with two indicated subdivided areas, one over the left eye at or near the hairline (sub-divided area 1), and one near the top of the left cheekbone (sub-divided area 2). FIGS. 40 and 41 illustrate the detail of these areas 1 and 2, respectively, being the 3D analog of FIG. 2, item 241. FIGS. 40 and 41 are at a high magnification and thus show the individual mesh triangles clearly.

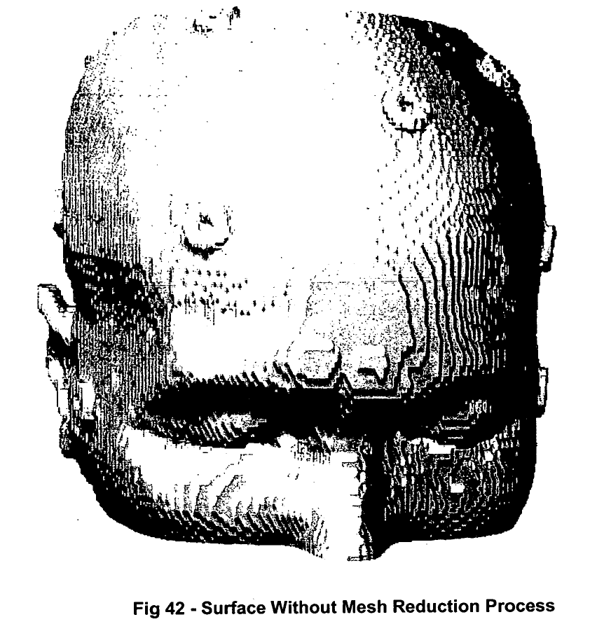

FIG. 42 is another view of the surface of FIG. 23, depicting a solid mode mesh surface.

As can be seen with reference to FIGS. 16-41, a surface created according to an exemplary embodiment of the present invention can be displayed, for example, as a solid surface, where each of the polygons comprising it is filled in to create a solid 3D surface, or for example, it can be displayed as a “wireframe” surface, depicting just the edges of the polygonal surfaces comprising the overall surface.

As noted, to minimize complexity mesh reduction can be used to reduce the number of polygons required to display the surface. Mesh reduction can be implemented according to known techniques. Additionally, for example, mesh reduction can be implemented using the following technique:

Mesh Reduction

According to experiments performed by the inventors, for a 256×256×256 CT data set a mesh surface created according to the methods of the present invention can have more than 200,000 triangles. Accordingly, it can be difficult to use such a mesh object for real-time user interaction because of the large number of triangles and the large computing demand necessary to render such an object in real-time. Thus, in exemplary embodiments of the present invention, the triangle number can be reduced to a lower level. However, if the triangle number is reduced, some accuracy can be lost. Thus, it is important to minimize the loss of accuracy when implementing mesh reduction. In exemplary embodiments of the present invention, mesh reduction can be implemented as follows.

1) Smooth the Surface

A surface generated according to the present invention by dividing voxels tries to include every inside voxel within itself. As a result, the surface can become a little jagged. As shown in FIG. 42, the result is a little like the shape after digitization. To reduce more triangles, it would be better to smooth the surface.

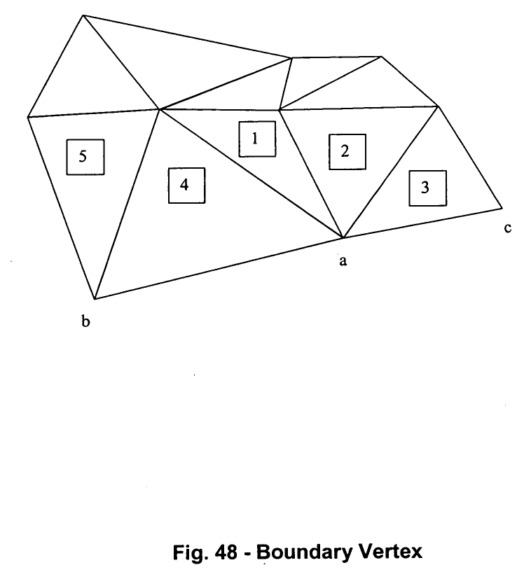

The following exemplary definitions can be used in an exemplary implementation:
Neighbor: For vertex a (xₐ, yₐ, zₐ), vertex i (xᵢ, yᵢ, zᵢ) is a neighbor of vertex a if and only if line ai is an edge of one or more than one triangles in the surface;
Neighbor Number NumOfNei(i): The number of neighbor of a vertex i;
Neighbor Triangle: If vertex a (xₐ, yₐ, zₐ) is a vertex of a triangle Tri(j), Tri(j) is a neighbor triangle of a;
Neighbor Triangle Number NumOfNeiTri(i): The neighbor triangle number of vertex i;
Surface vertex sν(i): If NumOfNeiTri(i)=NumOfNei(i), then vertex i is defined as a surface vertex;
Boundary vertex bν(i): If NumOfNeiTri(i)≠NumOfNei(i), then vertex i is defined as a surface vertex;
Boundary vertex neighbor NumOfBNei(i): For a boundary vertex, it is defined as the number of boundary neighbors among its neighbor. In FIG. 48, vertices a, b, c are boundary vertices. Vertices b and c are boundary vertex neighbors of vertex a.

In exemplary embodiments of the present invention, a new coordinate (x_{new}, y_{new}, z_{new}) of a surface voxel sv(a) can be smoothed according to its old coordinates and its neighbors' coordinates.

$${x}_{new} = ( {x}_{a} + {\sum }_{i = 1}^{NumofNei ( a )} {x}_{i} ) / ( NumofNei ( a ) + 1 )$$

$${y}_{new} = ( {y}_{a} + {\sum }_{i = 1}^{NumofNei ( a )} {y}_{i} ) / ( NumofNei ( a ) + 1 )$$

$${z}_{new} = ( {z}_{a} + {\sum }_{i = 1}^{NumofNei ( a )} {z}_{i} ) / ( NumofNei ( a ) + 1 )$$

Similarly, in exemplary embodiments of the present invention, a new coordinate (x_{new}, y_{new}, z_{new}) of a boundary voxel bv(a) can be smoothed according to its old coordinates and its boundary neighbors' coordinates.

$${x}_{new} = ( {x}_{a} + {\sum }_{i = 1}^{NumofBNei ( a )} {x}_{i} ) / ( NumofBNei ( a ) + 1 )$$

$${y}_{new} = ( {y}_{a} + {\sum }_{i = 1}^{NumofBNei ( a )} {y}_{i} ) / ( NumofBNei ( a ) + 1 )$$

$${z}_{new} = ( {z}_{a} + {\sum }_{i = 1}^{NumofBNei ( a )} {z}_{i} ) / ( NumofBNei ( a ) + 1 )$$

While more smoothing loops can reduce the number of triangles, more accuracy can be lost as a result. Thus, in exemplary embodiments of the present invention a balance can be reached between how many times the smoothing process should be run and how much accuracy should be kept. According to experiments performed by the inventors, if the smoothing process is run two times, good results can be obtained. In general, computing resources and accuracy requirements will determine the number of smoothing processes to run in a given exemplary implementation.

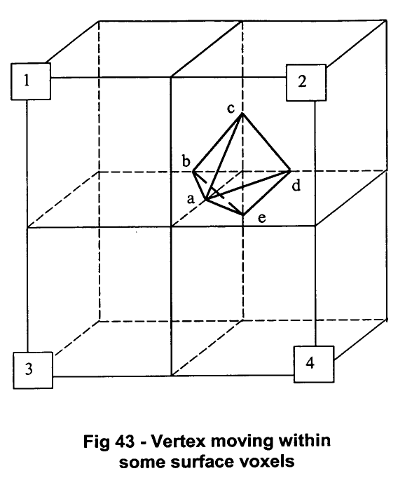

In most cases, this smoothing process will change the vertex position within some surface voxels, so it not too much accuracy will be lost. As shown in FIG. 43, a will move around within surface voxels 1, 2, 3 and 4.

2). Merging of Two Vertices

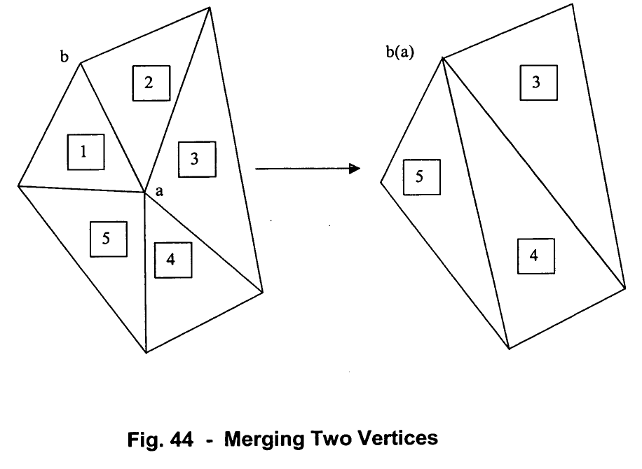

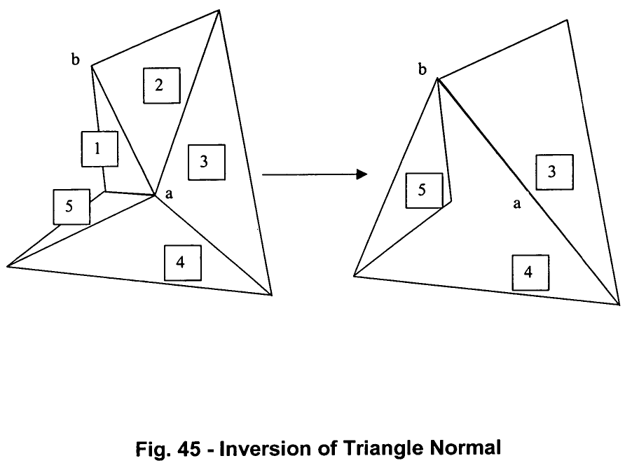

FIG. 44 illustrates the merging of two vertices according to an exemplary embodiment of the present invention. Assuming that triangles 1, 2, 3, 4 and 5 in FIG. 44 have a same normal vector in 3D space, which means they are in the same plane, it would appear that the five triangles can be replaced with 3, 4 and 5 three triangles by moving vertex a to b. But this is not always the case. Moving a vertex to a new position can, in some cases, cause unexpected results. For example, in FIG. 45, after moving vertex a to b, the normal vector of triangle 5 is reversed, and there is an overlay between triangle 5 and triangle 4.

In general, the triangles around a vertex are not in the same plane. What is desired is to determine how much those triangles can be considered as being in a plane as a measure of legitimacy of vertex moving. In exemplary embodiments of the present invention the normal difference among those triangles can be, for example, chosen as a parameter. The normal difference can be represented by the angle between the normal vectors of two triangles. In FIG. 44, it can be seen that the areas of triangles 1 and 2 are occupied by triangles 3, 4, 5. Thus, it is important that the normal vectors of triangles 3, 4, and 5 should not be too much different from that of triangles 1 and 2. Here a threshold T_{angle} can be defined. If the normal angle is greater than T^{angle}, then the proposed vertex move should stopped.

To prevent the normal vector inversion from happening, as shown in FIG. 45, in exemplary embodiments the normal vectors of the changed triangles can be computed as well as the angle between those normal vectors and that of their adjacent triangles. If any of such angles is greater than 90°, then the proposed movement should be stopped.

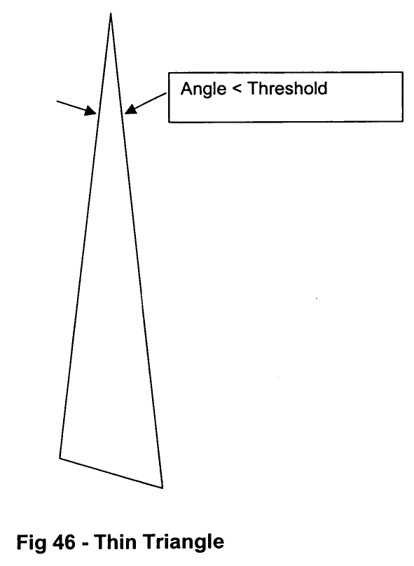

During a vertex movement process, it is important to try to avoid generating a thin triangle, as shown for example in FIG. 46. A thin triangle can cause problems in volume rendering and deformation modeling. In exemplary embodiments of the present invention, for example, a triangle with one angle less than 10° be defined as a thin triangle.

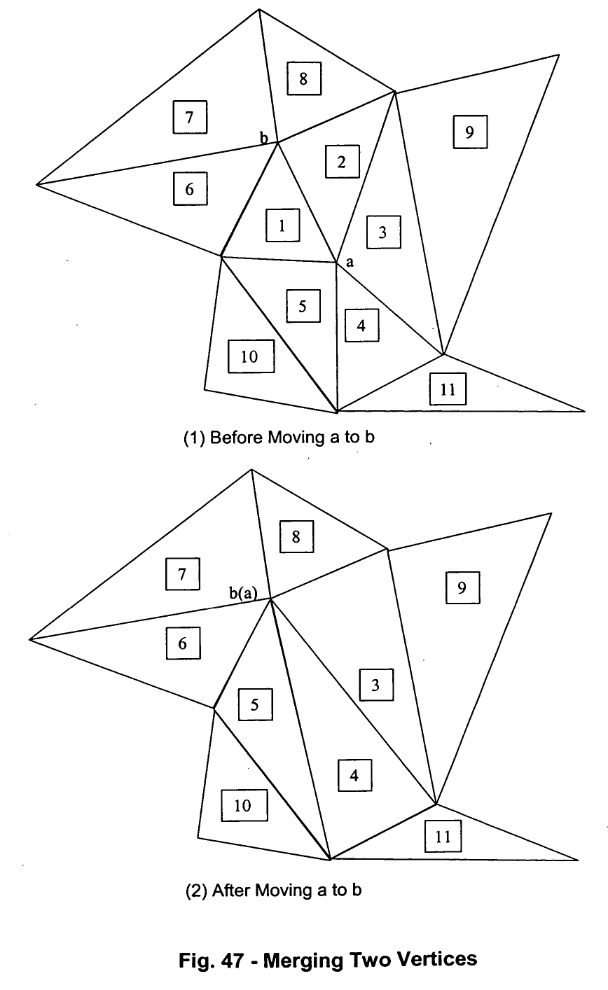

For the case shown in FIG. 47, an exemplary process to check whether vertex a can be moved to one of its neighbor (vertex b) can be implemented, for example, in the following steps:

a. Same Plane Test

Compute the normal vector Normal(i) for every triangle in FIG. 47(1);

Compute the angle AngleBetween(1, 2) between the normal vector Normal(1) and Normal(2).
If AngleBetween(1, 2)≧T_{angle}, vertex a can't be moved to vertex b;
If AngleBetween(1, 3)≧T_{angle}, vertex a can't be moved to vertex b;
If AngleBetween(1, 4)≧T_{angle}, vertex a can't be moved to vertex b;
If AngleBetween(1, 5)≧T_{angle}, vertex a can't be moved to vertex b;
If AngleBetween(2, 3)≧T_{angle}, vertex a can't be moved to vertex b;
If AngleBetween(2, 4)≧T_{angle}, vertex a can't be moved to vertex b;
If AngleBetween(2, 5)≧T_{angle}, vertex a can't be moved to vertex b;

b. Thin Triangle Test

To avoid thin triangles, all triangles around vertex a except those being removed should be checked. Assume vertex a is to be moved to vertex b, the three angles of each of triangles 3, 4 and 5 should be computed because one of the three vertices of the three triangles is changed from a to b. If any of such angles is less than a user defined threshold (for example, 10°), this proposed movement should be stopped.

c. Normal Inversion Test

Assuming vertex a is to be moved to vertex b, as shown in FIG. 47(2), to do normal inverse test, all triangles around vertex a except those being removed should be checked. In FIG. 47(2), triangles 3, 4, 5 should be checked. For every triangle amongst triangles 3, 4, and 5, the angle of the normal vectors between the triangle and its edge neighbors should be computed.

For triangle 3:
If AngleBetween(3, 8)≧90°, vertex a can't be moved to vertex b;
If AngleBetween(3, 9)≧90°, vertex a can't be moved to vertex b;
If AngleBetween(3, 4)≧90°, vertex a can't be moved to vertex b;

If a proposed vertex movement passes all the above tests, this vertex can be moved to its corresponding neighbor in exemplary embodiments of the present invention.

d) Boundary Vertex

A boundary vertex can only be moved to a boundary vertex neighbor. In FIG. 48, vertex a only can be moved to its boundary vertex neighbors b or c. Similarly, the Same Plane Test, Thin Triangle Test and Normal Inversion Test, mentioned above for a surface vertex, can, for example, also be applied to boundary vertex movement. Additionally, in exemplary embodiments, there is another test that should be applied to boundary vertex movement—the edge angle test. In FIG. 48, assume vertex a is to be moved to vertex b. The area of Triangle 4 will be occupied by triangles 1, 2, and 3. If vertices a, b and c are in the same line and triangles 1, 2, 3 and 4 are in the same plane, then implementing the proposed movement will not lose any accuracy.

e) Edge Angle Test—compute the angle of the two boundary edges. If the angle is greater than a user defined threshold, then this proposed movement should be stopped;

f) Remove Vertices Generated by Subdivision

Sometimes certain small features which really exist in the data are not of interest. Those small features are generally only one or a few voxels in size. In general, such features appear because of noise or digitization. This type of small feature is usually generated by a subdividing process. To remove such small features, those vertices from any subdivision can be removed. This process should preferably be performed, for example, at the beginning of a mesh reduction process.

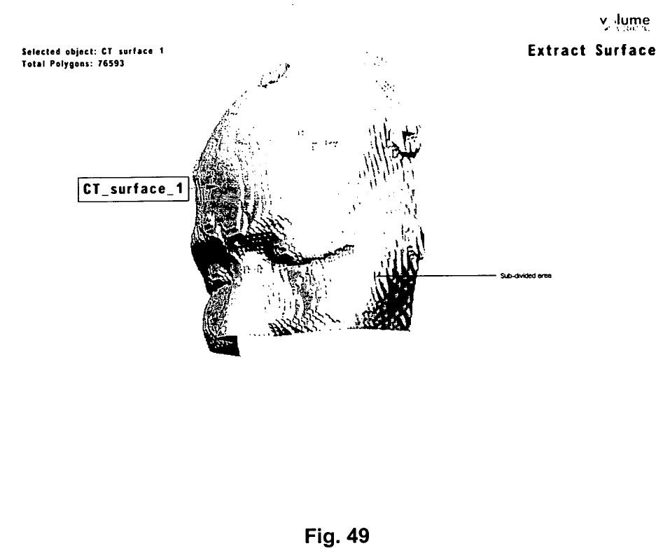

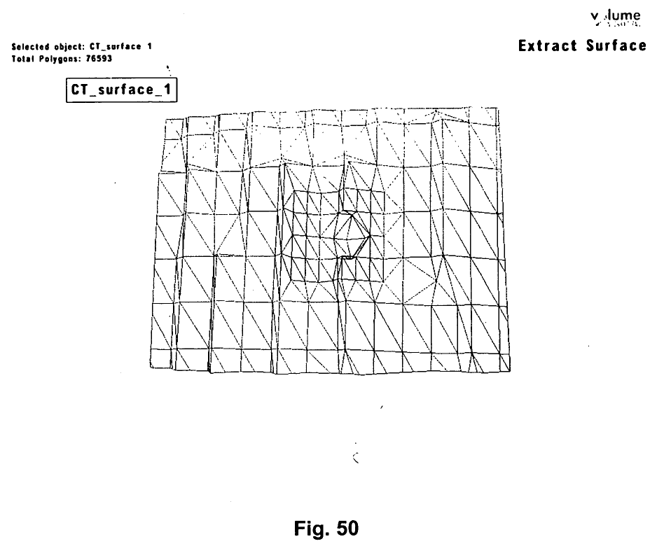

In exemplary embodiments of the present invention, criteria can be defined, for example, to determine which features should be abandoned. This step can be performed, for example, according to the number of vertices from subdivision within one group. A group of vertices from subdivision can be defined as the maximum vertices from subdivision whose neighbors, except for those neighbors who are in this group, are only surface vertexes. FIGS. 49 and 50 show examples of a subdivided vertex. FIG. 49 shows an exemplary screen shot of a surface representing a portion of the skin of a patient's head generating according to an exemplary embodiment of the present invention. The line in the figure points to an area including some subdivided vertices. As can be seen, this area is a very small feature in the surface. FIG. 50 depicts a zoom of the subdivided portion of the surface, shown in wireframe mode.

In exemplary embodiments of the present invention, an exemplary process to remove vertices created by subdivision can be thus described as follows: for every vertex from subdivision in the group, move it to one of its neighbors, which must be a surface vertex.

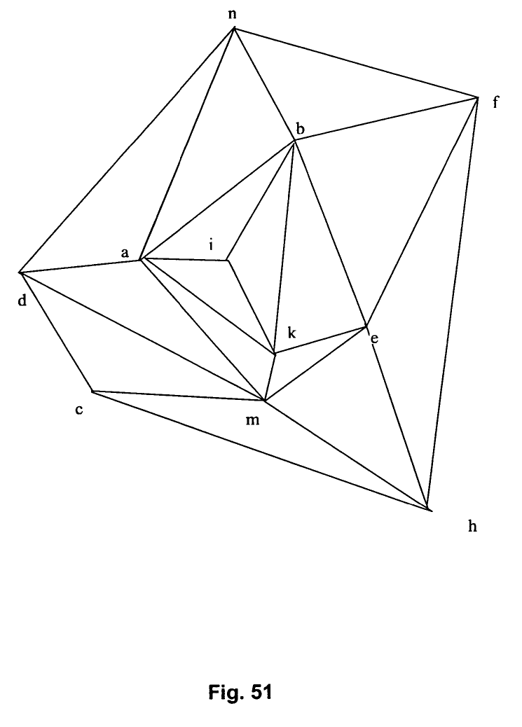

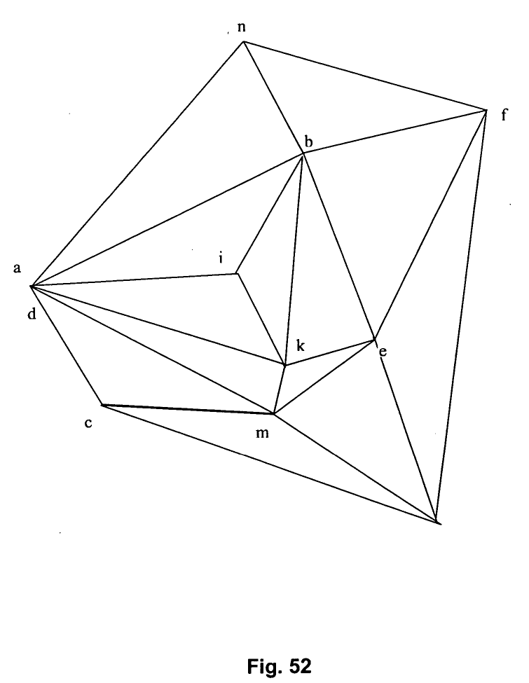

The above process can be iterated, for example, until, for example, all vertices from subdivision in the group have been removed. FIG. 51 shows an example of this process. Vertices a, b, e, i, k, and m are all vertices generated by subdivision, whereas all the others are surface vertices. If the user-predefined small feature threshold is greater than, for example, 6, then those vertices can be removed. FIG. 52 shows a first step in this process of moving vertex a to d—its surface vertex neighbor. Similar processing can be applied to the other vertices from subdivision. As seen in FIG. 51, vertex i did not originally have any surface vertex neighbor. But after vertex a was moved to d, as shown in FIG. 52, vertex d becomes a surface vertex neighbor of vertex i.

g) Special Cases

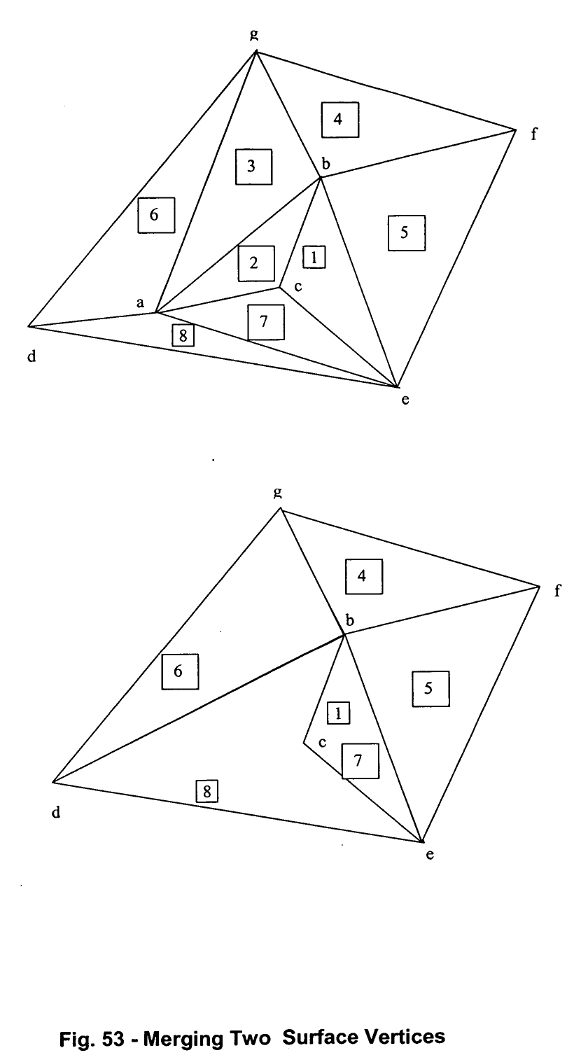

In general, a surface vertex will share two different neighbor vertices with one of its surface neighbors. But there are exceptions. In FIG. 53, for example, vertex a shares three neighbors, i.e., g, c and e with its surface neighbor b. If vertex a is moved to b, some unexpected results can appear. For example, in FIG. 53(2) (the bottom frame of the figure), the results of moving vertex a to b are shown. Vertex b now has 5 vertex neighbors c, d, e, f and g. But vertex b has six triangles around it—triangles 1, 4, 5, 6, 7 and 8. This should not occur to a surface vertex.

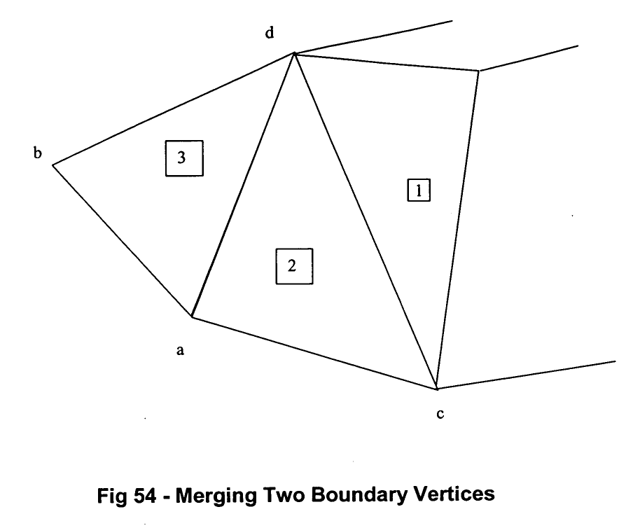

A boundary vertex, in general, has only two boundary vertices as its neighbors. But FIG. 54 illustrates an exception. Vertex a has three boundary vertex neighbors. This can cause confusion in the algorithm described above for a boundary vertex.

To avoid such special cases, a sharing vertex number check can, for example, be implemented in exemplary embodiments of the present invention, as follows:
To move surface vertex a to surface vertex b, a must share 2 and only 2 vertexes with surface vertex b; and
To move boundary vertex a to boundary vertex b, a must share 2 and only 2 boundary vertexes with surface b.
   Hole Closing and Volume Measurement

The methods of exemplary embodiments of the present invention as described above will not generate any holes in a mesh surface if there are no holes in the original data. But sometimes when the original data is cropped, there can be some holes along the crop boundaries. It is necessary to close those holes when a surface generated according to exemplary embodiments of the present invention is used to measure volumes of the original data.

In exemplary embodiments of the present invention, there are two methods that can be used to close a hole in a triangle mesh generated according to exemplary embodiments of the present invention.

1). A first exemplary method is to add six empty slices to the cropped data around the cropping box. Applying the methods of the present invention to the new data (i.e., the cropped data with six empty slices surrounding it) to generate a mesh surface, the resulting triangle mesh will be perfectly closed.

It is noted that this method may have some special utilities. The triangles from the six extra empty slices can be used for special purposes. For example, they can be used to compute volume enclosed by the mesh surface. It is also easy to make them not for display. If only outer surface is wanted, they can be used to remove interior structure, which is difficult to be removed through mesh reduction.

2). A second algorithm is, for example, to search for the hole and close it. As the hole is due to the cropped boundary, it must locate on the boundary. The hole is composed of a 2D polygon. By triangulating the 2D polygon and adding the resulting triangles to the mesh object, the hole will disappear.

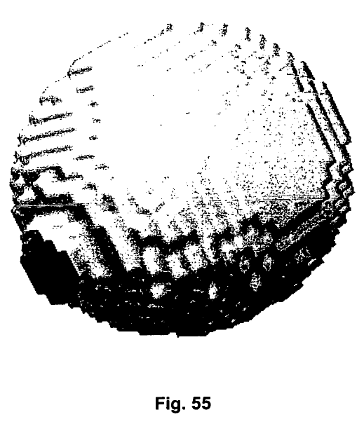

FIG. 55 shows an example volumetric sphere, obtained from scanning a phantom object via CT and segmenting the scan. Because the object is actually a sphere sitting on a pole, when segmenting just the sphere a hole in the surface of the volumetric object results where the pole attaches to the sphere.

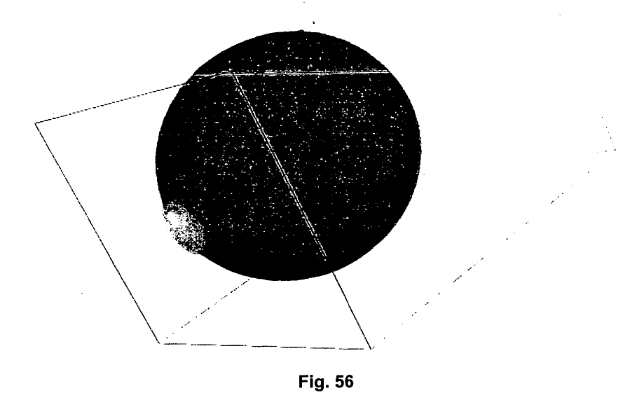

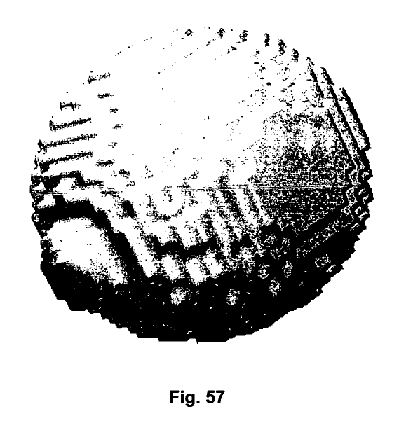

FIG. 56 shows a mesh surface of this object generated according to an exemplary embodiment of the present invention (shown within a crop box). There is a hole in the triangle mesh. FIG. 57 shows the mesh surface (solid mode and magnified) after processing by the exemplary Hole Closing algorithm described above.

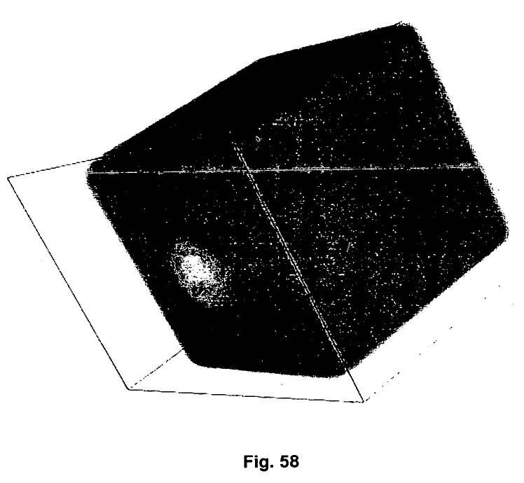

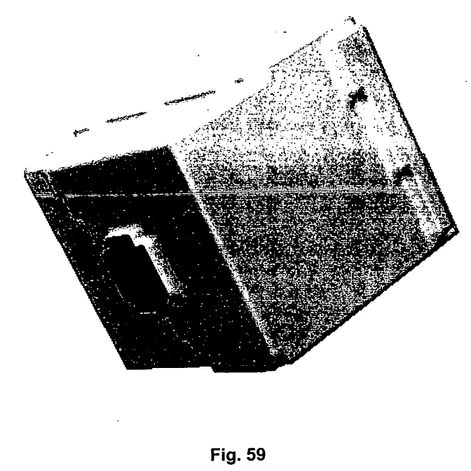

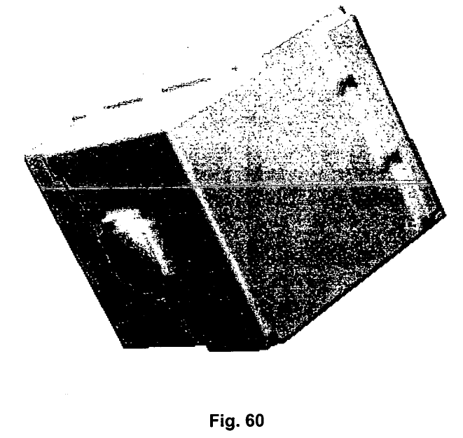

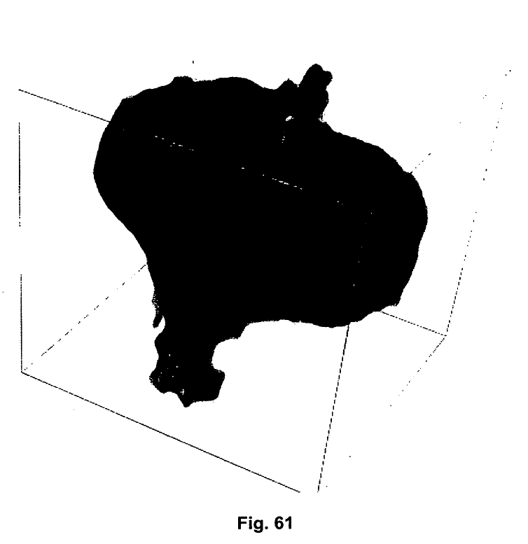

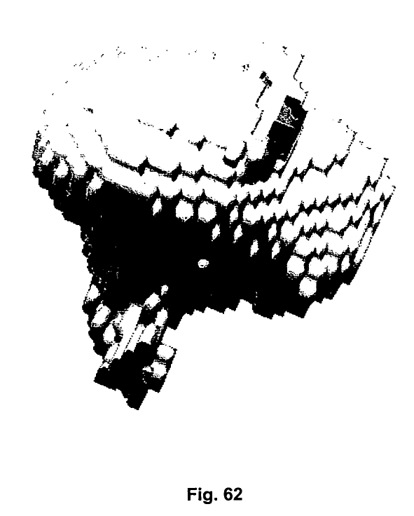

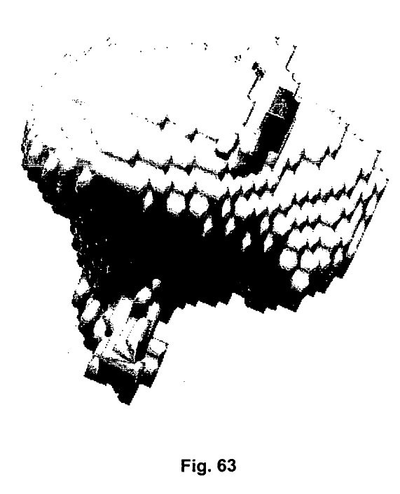

FIGS. 58-60 show a volumetric phantom cube object segmented form scan data, a mesh surface (as generated by the methods of the present invention) in solid mode of the same object, with a hole at the base, and the same mesh surface after Hole Closing, respectively. Finally, using some actual data, FIGS. 61-63 show a tumor segmented from MR scan data, a mesh surface (as generated by the methods of the present invention) in solid mode of the same object, with a hole at the base, and the same mesh surface after Hole Closing (as implemented by the methods of the present invention), respectively.

Once Hole Closing has been applied, the volume of the now closed mesh surface can be calculated using known techniques. Table 13 below shows exemplary volume measurement results for these objects.

TABLE 13

| Volume | Real physical | Computed | Computed |
|---|---|---|---|
| Measurement | volume | Voxel Volume | Closed Surface |
| (cm³) | (cm³) | (cm³) | Volume (cm³) |
| Sphere | 9.202 | 8.80 | 9.002 |
| Cube | 8.00 | 7.87 | 8.018 |
| Tumor | N/A | 10.30 | 11.494 |

It is noted that there was no actual tumor which could be measured, as the volumes were calculated form scan data. As can be seen, the volume of the closed mesh surfaces generated from the scanned objects are considerably more accurate than simply taking the volume of the segmented object. This is expected, inasmuch as for sparing thresholds the segmented objected is smaller than the actual object and smaller than a mesh surface of the segmented object as generated according to exemplary embodiments of the present invention. The volume measurements for the phantom objects indicate that the mesh surfaces are topologically correct, and thus allow the volume of the closed mesh surface for an object which can only be known from medical imaging, such as the tumor of FIGS. 61-63, to be taken as accurate with confidence.

Exemplary Pseudocode

An exemplary embodiment according to the present invention can be implemented using the following pseudocode as a guideline, using known coding techniques, coding languages and compilers. The methods of exemplary embodiments according to the present invention can be implemented in any system arranged to store, process and display three-dimensional and volumetric data sets, such as, for example, the Dextroscope™ hardware and RadioDexter™ software provided by Volume Interactions Pte Ltd of Singapore.

I. Overview Pseudocode:

Input:
ORIVOLUME: 3 dimensional array, original volume data;
ORIVOLUME[k][j][i]: the Intensity of the corresponding voxel;
TS: threshold. The value of TS can be decided by user or by some algorithm.

Output:
Triangle_Mesh

Process:

```
Construct the binary volume VOL from the input data ORIVOLUME;
For every outside voxel VOL[k][j][i];
  compute its eᵢ₋, eᵢ₊, eⱼ₋, eⱼ₊, eₖ₋, eₖ₊, and ε value;
For every outside voxel VOL[k][j][i];
{
  compute its fᵢ₋, fᵢ₊, fⱼ₋, fⱼ₊, fₖ₋, fₖ₊, \overline{ε}ᵢ, \overline{ε}ⱼ, \overline{ε}ₖ, ε ;
    If ( ( (fᵢ₋is true) .AND. (fᵢ₊ is true) ).OR.
    ( (fⱼ₋is true) .AND. (fⱼ₊ is true) ).OR.
    ( (fₖ₋is true) .AND. (fₖ₊ is true) ) )
    {
      Construct a new 6×6×6 volume New_Vol using VOL[k][j][i] and its 26 neighbor;
      For every outside voxel in New_Vol
      compute its eᵢ₋, eᵢ₊, eⱼ₋, eⱼ₊, eₖ₋, eₖ₊ and ε value;
    For every outside voxel New_Vol[k][j][i] in New_Vol
    {
      compute its fᵢ₋, fᵢ₊, fⱼ₋, fⱼ₊, fₖ₋, fₖ₊ , \overline{ε}ᵢ, \overline{ε}ⱼ, \overline{ε}ₖ ε ;
        collect triangle strip within New_Vol[k][j][i];
    }
    }
    else
      collect triangle strip within VOL[k][j][i];
}
```

II. Detailed Pseudocode

A. Assumptions and Data Structure Definitions

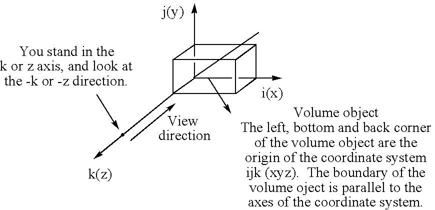

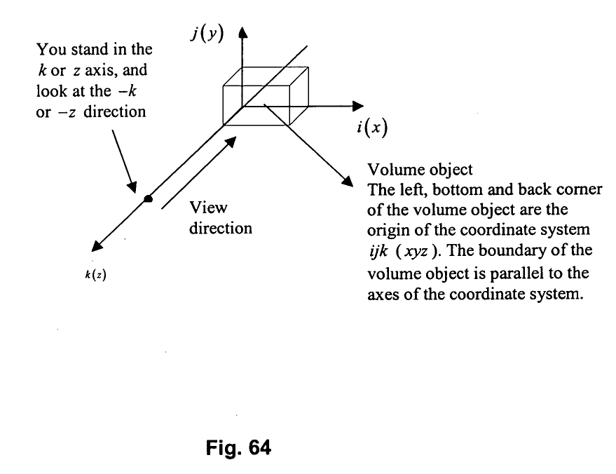

FIG. 64 illustrates the assumptions and orientational definitions for the volume objects.

Input Data:
ORIVOLUME: 3 dimensional array, original volume data;
ORIVOLUME[k][j][i]: the Intensity of the corresponding voxel;
TS: threshold. The value of TS can be decided by user or by some algorithm

Parameter:
VOL: 3 dimensional binary array. It has the same size as ORIVOLUME.
   Every element of VOL has a corresponding voxel in ORIVOLUME.
VOL[k][j][i]: binary value, 0 or 1;
VOXELSUR: 1 dimensional array. Every element saves three integers, the index of surface voxel

B. Exemplary Algorithm:

Step 1:

For every voxe ORIVOLUME[k][j][i] of the original volume data:

| | |
|---|---|
| { | |
| If ORIVOLUME[k][j][i] <TS, | //threshold test |
| VOL[k][j][i]=0; | //set as OUTSIDE voxel of binary array |
| else | |
| VOL[k][j][i]=1. | //set as INSIDE voxel of binary array |
| } | |

Step 2:

$$For every VOL [ k ] [ j ] [ i ] = 0 \text{:}$$

$$If ( \begin{matrix}( VOL [ k - 1 ] [ j - 1 ] [ i - 1 ] ⩵ 1 ) ‖ \\ ( VOL [ k - 1 ] [ j - 1 ] [ i ] ⩵ 1 ) ‖ \\ ( VOL [ k - 1 ] [ j - 1 ] [ i + 1 ] ⩵ 1 ) ‖ \\ ( VOL [ k - 1 ] [ j + 1 ] [ i - 1 ] ⩵ 1 ) ‖ \\ ( VOL [ k - 1 ] [ j + 1 ] [ i ] ⩵ 1 ) ‖ \\ ( VOL [ k - 1 ] [ j + 1 ] [ i + 1 ] ⩵ 1 ) ‖ \\ ( VOL [ k - 1 ] [ j ] [ i - 1 ] ⩵ 1 ) ‖ \\ ( VOL [ k - 1 ] [ j ] [ i ] ⩵ 1 ) ‖ \\ ( VOL [ k - 1 ] [ j ] [ i + 1 ] ⩵ 1 ) ‖ \\ ( VOL [ k ] [ j - 1 ] [ i - 1 ] ⩵ 1 ) ‖ \\ ( VOL [ k ] [ j - 1 ] [ i ] ⩵ 1 ) ‖ \\ ( VOL [ k ] [ j - 1 ] [ i + 1 ] ⩵ 1 ) ‖ \\ ( VOL [ k ] [ j + 1 ] [ i - 1 ] ⩵ 1 ) ‖ \\ ( VOL [ k ] [ j + 1 ] [ i ] ⩵ 1 ) ‖ \\ ( VOL [ k ] [ j + 1 ] [ i + 1 ] ⩵ 1 ) ‖ \\ ( VOL [ k ] [ j ] [ i - 1 ] ⩵ 1 ) ‖ \\ ( VOL [ k ] [ j ] [ i ] ⩵ 1 ) ‖ \\ ( VOL [ k ] [ j ] [ i + 1 ] ⩵ 1 ) ‖ \\ ( VOL [ k + 1 ] [ j - 1 ] [ i - 1 ] ⩵ 1 ) ‖ \\ ( VOL [ k + 1 ] [ j - 1 ] [ i ] ⩵ 1 ) ‖ \\ ( VOL [ k + 1 ] [ j - 1 ] [ i + 1 ] ⩵ 1 ) ‖ \\ ( VOL [ k + 1 ] [ j + 1 ] [ i - 1 ] ⩵ 1 ) ‖ \\ ( VOL [ k + 1 ] [ j + 1 ] [ i ] ⩵ 1 ) ‖ \\ ( VOL [ k + 1 ] [ j + 1 ] [ i + 1 ] ⩵ 1 ) ‖ \\ ( VOL [ k + 1 ] [ j ] [ i - 1 ] ⩵ 1 ) ‖ \\ ( VOL [ k + 1 ] [ j ] [ i ] ⩵ 1 ) ‖ \\ ( VOL [ k + 1 ] [ j ] [ i + 1 ] ⩵ 1 ) ‖\end{matrix} ) , push$$

(i, j, k) into VOXELSUR.

Step 3:

For every element in VOXELSUR, define:
Post_process (i, j, k)=FALSE;
eᵢ₋(i, j, k)=FALSE; eᵢ₊(i, j, k)=FALSE;
eⱼ₋(i, j, k)=FALSE; eⱼ₊(i, j, k)=FALSE;
eₖ₋(i, j, k)=FALSE; eₖ₊(i, j, k)=FALSE;
\overline{ε}ᵢ(i, j, k)=0; \overline{ε}ⱼ(i, j, k)=0; \overline{ε}ₖ(i, j, k)=0;
ƒᵢ₋(i, j, k)=FALSE; ƒᵢ₊(i, j, k)=FALSE;
ƒⱼ₋(i, j, k)=FALSE; ƒⱼ₊(i, j, k)=FALSE;
ƒₖ₋(i, j, k)=FALSE; ƒₖ₊(i, j, k)=FALSE;
εᵢ(i, j, k) FALSE; εⱼ(i, j, k)=FALSE; εₖ(i, j, k)=FALSE;
ε(i, j, k)=FALSE;

Step 4:

For every element in VOXELSUR:
If VOL[k][j][i−1]=1, eᵢ₋(i, j, k)=TRUE;
If VOL[k][j][i+1]=1, eᵢ₊(i, j, k)=TRUE;
If VOL[k][j−1][i]=1, eⱼ₋(i, j, k)=TRUE;
If VOL[k][j+1][i]=1, eⱼ₊(i, j, k)=TRUE;
If VOL[k−1][j][i]=1, eₖ₋(i, j, k)=TRUE;
If VOL[k+1][j][i]=1, eₖ₊(i, j, k)=TRUE;
   ε(i, j, k)=eᵢ₋(i, j, k)∥eᵢ₊(i, j, k)∥eⱼ₋(j, k)∥eⱼ₊(i, j, k)∥eₖ₋(i, j, k)∥eₖ₊(i, j, k)

Step 5:

For every element in VOXELSUR:

$$\begin{matrix}{f}_{i -} ( i , j , k ) = {e}_{i -} ( i , j , k ) \\ ‖ {e}_{i -} ( i , j - 1 , k ) ‖ {e}_{i -} ( i , j + 1 , k ) \\ ‖ {e}_{i -} ( i , j , k - 1 ) ‖ {e}_{i -} ( i , j , k + 1 ) \\ ‖ ( ( {e}_{j +} ( i , j - 1 , k - 1 ) ⩵ false ) \&\& \\ ( {e}_{k +} ( i , j - 1 , k - 1 ) ⩵ false ) \&\& \\ ( {e}_{i -} ( i , j - 1 , k - 1 ) ) ) \\ ‖ ( ( {e}_{j +} ( i , j - 1 , k + 1 ) ⩵ false ) \&\& \\ ( {e}_{k -} ( i , j - 1 , k + 1 ) ⩵ false ) \&\& \\ ( {e}_{i -} ( i , j - 1 , k + 1 ) ) ) \\ ‖ ( ( {e}_{j -} ( i , j + 1 , k - 1 ) ⩵ false ) \&\& \\ ( {e}_{k +} ( i , j + 1 , k - 1 ) ⩵ false ) \&\& \\ ( {e}_{i -} ( i , j + 1 , k - 1 ) ) ) \\ ‖ ( ( {e}_{j -} ( i , j + 1 , k + 1 ) ⩵ false ) \&\& \\ ( {e}_{k -} ( i , j + 1 , k + 1 ) ⩵ false ) \&\& \\ ( {e}_{i -} ( i , j + 1 , k + 1 ) ) )\end{matrix}$$

$$\begin{matrix}{f}_{i +} ( i , j , k ) = {e}_{i +} ( i , j , k ) \\ ‖ {e}_{i +} ( i , j - 1 , k ) ‖ {e}_{i +} ( i , j + 1 , k ) \\ ‖ {e}_{i +} ( i , j , k - 1 ) ‖ {e}_{i +} ( i , j , k + 1 ) \\ ‖ ( ( {e}_{j +} ( i , j - 1 , k - 1 ) ⩵ false ) \&\& \\ ( {e}_{k +} ( i , j - 1 , k - 1 ) ⩵ false ) \&\& \\ ( {e}_{i +} ( i , j - 1 , k - 1 ) ) ) \\ ‖ ( ( {e}_{j +} ( i , j - 1 , k + 1 ) ⩵ false ) \&\& \\ ( {e}_{k -} ( i , j - 1 , k + 1 ) ⩵ false ) \&\& \\ ( {e}_{i +} ( i , j - 1 , k + 1 ) ) ) \\ ‖ ( ( {e}_{j -} ( i , j + 1 , k - 1 ) ⩵ false ) \&\& \\ ( {e}_{k +} ( i , j + 1 , k - 1 ) ⩵ false ) \&\& \\ ( {e}_{i +} ( i , j + 1 , k - 1 ) ) ) \\ ‖ ( ( {e}_{j -} ( i , j + 1 , k + 1 ) ⩵ false ) \&\& \\ ( {e}_{k -} ( i , j + 1 , k + 1 ) ⩵ false ) \&\& \\ ( {e}_{i +} ( i , j + 1 , k + 1 ) ) )\end{matrix}$$

$$\begin{matrix}{f}_{j -} ( i , j , k ) = {e}_{j -} ( i , j , k ) \\ ‖ {e}_{j -} ( i - 1 , j , k ) ‖ {e}_{j -} ( i + 1 , j , k ) \\ ‖ {e}_{j -} ( i , j , k - 1 ) ‖ {e}_{j -} ( i , j , k + 1 ) \\ ‖ ( ( {e}_{i +} ( i - 1 , j , k - 1 ) ⩵ false ) \&\& \\ ( {e}_{k +} ( i - 1 , j , k - 1 ) ⩵ false ) \&\& \\ ( {e}_{j -} ( i - 1 , j , k - 1 ) ) ) \\ ‖ ( ( {e}_{i +} ( i - 1 , j , k + 1 ) ⩵ false ) \&\& \\ ( {e}_{k -} ( i - 1 , j , k + 1 ) ⩵ false ) \&\& \\ ( {e}_{j -} ( i - 1 , j , k + 1 ) ) ) \\ ‖ ( ( {e}_{i -} ( i + 1 , j , k - 1 ) ⩵ false ) \&\& \\ ( {e}_{k +} ( i + 1 , j , k - 1 ) ⩵ false ) \&\& \\ ( {e}_{j -} ( i + 1 , j , k - 1 ) ) ) \\ ‖ ( ( {e}_{i -} ( i + 1 , j , k + 1 ) ⩵ false ) \&\& \\ ( {e}_{k -} ( i + 1 , j , k + 1 ) ⩵ false ) \&\& \\ ( {e}_{j -} ( i + 1 , j , k + 1 ) ) )\end{matrix}$$

$$\begin{matrix}{f}_{j +} ( i , j , k ) = {e}_{j +} ( i , j , k ) \\ ‖ {e}_{j +} ( i - 1 , j , k ) ‖ {e}_{j +} ( i + 1 , j , k ) \\ ‖ {e}_{j +} ( i , j , k - 1 ) ‖ {e}_{j +} ( i , j , k + 1 ) \\ ‖ ( ( {e}_{i +} ( i - 1 , j , k - 1 ) ⩵ false ) \&\& \\ ( {e}_{k +} ( i - 1 , j , k - 1 ) ⩵ false ) \&\& \\ ( {e}_{j +} ( i - 1 , j , k - 1 ) ) ) \\ ‖ ( ( {e}_{i +} ( i - 1 , j , k + 1 ) ⩵ false ) \&\& \\ ( {e}_{k -} ( i - 1 , j , k + 1 ) ⩵ false ) \&\& \\ ( {e}_{j +} ( i - 1 , j , k + 1 ) ) ) \\ ‖ ( ( {e}_{i -} ( i + 1 , j , k - 1 ) ⩵ false ) \&\& \\ ( {e}_{k +} ( i + 1 , j , k - 1 ) ⩵ false ) \&\& \\ ( {e}_{j +} ( i + 1 , j , k - 1 ) ) ) \\ ‖ ( ( {e}_{i -} ( i + 1 , j , k + 1 ) ⩵ false ) \&\& \\ ( {e}_{k -} ( i + 1 , j , k + 1 ) ⩵ false ) \&\& \\ ( {e}_{j +} ( i + 1 , j , k + 1 ) ) )\end{matrix}$$

$$\begin{matrix}{f}_{k -} ( i , j , k ) = {e}_{k -} ( i , j , k ) \\ ‖ {e}_{k -} ( i - 1 , j , k ) ‖ {e}_{k -} ( i + 1 , j , k ) \\ ‖ {e}_{k -} ( i , j - 1 , k ) ‖ {e}_{k -} ( i , j + 1 , k ) \\ ‖ ( ( {e}_{i +} ( i - 1 , j - 1 , k ) ⩵ false ) \&\& \\ ( {e}_{j +} ( i - 1 , j - 1 , k ) ⩵ false ) \&\& \\ ( {e}_{k -} ( i - 1 , j - 1 , k ) ) ) \\ ‖ ( ( {e}_{i +} ( i - 1 , j + 1 , k ) ⩵ false ) \&\& \\ ( {e}_{j -} ( i - 1 , j + 1 , k ) ⩵ false ) \&\& \\ ( {e}_{k -} ( i - 1 , j + 1 , k ) ) ) \\ ‖ ( ( {e}_{i -} ( i + 1 , j - 1 , k ) ⩵ false ) \&\& \\ ( {e}_{j +} ( i + 1 , j - 1 , k ) ⩵ false ) \&\& \\ ( {e}_{k -} ( i + 1 , j - 1 , k ) ) ) \\ ‖ ( ( {e}_{i -} ( i + 1 , j + 1 , k ) ⩵ false ) \&\& \\ ( {e}_{j -} ( i + 1 , j - 1 , k ) ⩵ false ) \&\& \\ ( {e}_{k -} ( i + 1 , j + 1 , k ) ) )\end{matrix}$$

$$\begin{matrix}{f}_{k +} ( i , j , k ) = {e}_{k +} ( i , j , k ) \\ ‖ {e}_{k +} ( i - 1 , j , k ) ‖ {e}_{k +} ( i + 1 , j , k ) \\ ‖ {e}_{k +} ( i , j - 1 , k ) ‖ {e}_{k +} ( i , j + 1 , k ) \\ ‖ ( ( {e}_{i +} ( i - 1 , j - 1 , k ) ⩵ false ) \&\& \\ ( {e}_{j +} ( i - 1 , j - 1 , k ) ⩵ false ) \&\& \\ ( {e}_{k +} ( i - 1 , j - 1 , k ) ) ) \\ ‖ ( ( {e}_{i +} ( i - 1 , j + 1 , k ) ⩵ false ) \&\& \\ ( {e}_{j -} ( i - 1 , j + 1 , k ) ⩵ false ) \&\& \\ ( {e}_{k +} ( i - 1 , j + 1 , k ) ) ) \\ ‖ ( ( {e}_{i -} ( i + 1 , j - 1 , k ) ⩵ false ) \&\& \\ ( {e}_{j +} ( i + 1 , j - 1 , k ) ⩵ false ) \&\& \\ ( {e}_{k +} ( i + 1 , j - 1 , k ) ) ) \\ ‖ ( ( {e}_{i -} ( i + 1 , j + 1 , k ) ⩵ false ) \&\& \\ ( {e}_{j -} ( i + 1 , j - 1 , k ) ⩵ false ) \&\& \\ ( {e}_{k +} ( i + 1 , j + 1 , k ) ) )\end{matrix}$$

Step 6:

For every element in VOXELSUR:
If (((ƒᵢ₋(i, j, k)=TRUE)&&(ƒᵢ₊(i, j, k)=TRUE))∥
   ((ƒⱼ₋(i, j, k)=TRUE)&&(ƒⱼ₊(i, j, k)=TRUE))∥
   ((ƒₖ₋(i, j, k)=TRUE)&&(ƒₖ₊(i, j, k)=TRUE))),
Then Post_process(i, j, k)=TRUE;

Step 7:

For every element in VOXELSUR:
If Post_process=FALSE,

\overline{ε}ᵢ(i, j, k)=numberof TRUE among
{eᵢ₋(i, j−1, k), eᵢ₋(i, j, k−1), eᵢ₋(i, j+1, k), eᵢ₋(i, j, k+1), eᵢ₊(i, j−1, k), eᵢ₊(i, j, k−1), eᵢ₋(i, j+1, k), eᵢ₊(i, j, k+1)}
\overline{ε}ⱼ(i, j, k)=numberof TRUE among
   {eⱼ₋(i−1, j, k,), eⱼ₋(i, j, k−1), eⱼ₋(i+1, j, k), eⱼ₋(i, j, k+1), eⱼ₊(i−1, j, k), eⱼ₊(i, j, k−1), eⱼ₊(i+1, j, k), eⱼ₊(i, j, k+1)}
\overline{ε}ₖ(i, j, k)=numberof TRUE among
   {eₖ₋(i−1, j, k), eₖ₋(i, j−1, k), eₖ₋(i+1, j, k), eₖ₋(i, j+1, k), eₖ₊(i−1, j, k), eₖ₊(i, j−1, k), eₖ₊(i+1, j, k), eₖ₊(i, j+1, k)}
      εᵢ(i, j, k)=(eᵢ₋(i, j, k)∥eᵢ₊(i, j, k))∥(\overline{ε}ᵢ(i, j, k)=2)
      εⱼ(i, j, k)=(eⱼ₋(i, j, k)∥eⱼ₊(i, j, k))∥(\overline{ε}ⱼ(i, j, k)=2)
      εₖ(i, j, k)=(eₖ₌(i, j, k)∥eₖ₊(i, j, k))∥(\overline{ε}ₖ(i, j, k)=2)

Based upon the ten values
(ƒᵢ₋(i, j, k), ƒᵢ₊(i, j, k), ƒⱼ₋(i, j, k), ƒⱼ₊(i, j, k), ƒₖ₋(i, j, k), ƒₖ₊(i, j, k) εᵢ(i, j, k), εⱼ(i, j, k), εₖ(i, j, k), ε(i, j, k),
   decide the surface within ORIVOLUME[k][j][i].

Step 8:

For every element in VOXELSUR:
If Post_process=TRUE,
Divide ORIVOLUME[k][j][i] and its 26 neighbors to construct a new small volume 6×6×6. Every ORIVOLUME[k±1, k][j±1, j][i±1, i] is subdivided into eight equal children, which have the same INTENSITY values as did their parents (i.e., each of the 27 voxels have the intensity value as did their parent prior to the subdivision). Using the new volume as INPUT, perform the above 7 steps.

Step 9:

Group the results of Step 7 to construct the surface of the object.

C. Mesh Reduction

Input:
1) Mesh:
VER: Vertices are saved in a 1D array VER. Every VERᵢ saves a 3D coordinate.
TRI: Triangles are saved in a 1D array TRI. Every TRIᵢ saves the three vertices' indexes (three integers) in VER.
2) ANGLE_T: User defined angular threshold, which is used to determine whether two triangles can be assumed to be in the same plane;
3) BOUN_ANGLE_T: User defined threshold, which is used to determine whether two boundary edges can be assumed to be in the same line;
4) TRIANGLE_N: User defined threshold, which is the expected maximum triangle number in the final result;
5) PERCENTAGE_T: User defined threshold. If the reduced percentage in one loop is less than the threshold;
6) MIN_ANGLE_T: The minimum angle of a triangle in the final result should not be less than the MIN_ANGLE_T;

Output:
TRIANGLE_MESH:
   NEW_VER
   NEW_TRI

Process:
While (NewTriangleNumber>TRIANGLE_N .OR.
   Percentage>PERCENTAGE_T)
{
   For every unremoved vertex vᵢ of the input triangle mesh
   {
      If vᵢ is a special case, continue to next vᵢ;
      If vᵢ is a non_boundary vertex and only has three neighboring vertexes, move vertex vᵢ to any of its neighbors and continue to next vᵢ;
      For every vertex neighbor vⱼ of vᵢ:
      {
If SAME_PLANE_TEST failed, continue to next vⱼ;
If THIN_TRIANGLE_TEST failed, continue to next vⱼ;
If NORMAL_INVERSE_TEST failed, continue to next vⱼ;
If vᵢ is a boundary vertex .AND. EDGE_ANGLE_TEST failed, continue to next vⱼ;
Move vᵢ to vⱼ, update vertex and triangle information for vⱼ, continue to next vᵢ;
   }
      }
      Compute NewTriangleNumber and Percentage;
      SmoothVertexArray( );
}

D. Hole Closing
Input:
Mesh:
VER: Vertexes are saved in a 1D array VER. Every VERᵢ saves a 3D coordinate.
TRI: Triangles are saved in a 1D array TRI. Every TRIᵢ saves the three vertices' indexes in VER.
Output: TRIANGLE_MESH without boundary vertex:
Process:
While (there is any unprocessed boundary vertex)
{
   For a unprocessed boundary vertex vᵢ of the input triangle mesh
   {
      If vᵢ doesn't have two and only two boundary neighbors, continue to next νᵢ;
      Clear the polygon list L_{poly};
      Use vertex neighboring information, construct a boundary loop L_{poly} seeding from vertex vᵢ: all elements in the boundary loop should have at least one same coordinate among (x, y, z);
      Triangulate L_{poly} and add the resulting triangles into the triangle mesh;
   }
}
Output the new triangle mesh;

Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte Ltd of Singapore, running the RadioDexter software, or any similar or functionally equivalent 3D data set interactive display systems, are systems on which the methods of the present invention can easily be implemented.

Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of displaying a 3D computer model or models of a tube-like structure in a 3D data display system.

While this invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

There are three Appendices attached hereto (Appendices I, II and III) which illustrate various possible cases for a surface voxel. These three appendices are each hereby fully incorporated herein by this reference as if fully set forth herein. Of necessity these appendices associate an appropriate neighbor information vector for each voxel possibility with a picture. These illustrations are of the voxel's neighbors (Appendix I), the shape and orientation of a polygonal surface dividing the voxel (Appendix II) and a combination of both for various possible voxel neighbor configurations (Appendix III). The combination of illustration with adjacent text is the highest and best means to convey the abstract information of the case vectors. If on formal grounds these Appendices are objected to, Applicant reserves the right to split the material in the Appendices into text and drawings, and to amend the specification to add new drawings to the application comprising each illustration in the Appendices, and to describe each of said drawings in added text to the specification. However Applicant urges that the Appendices do in fact provide the most efficient and clear presentation of this material, and as such should be acceptable.

1. A method of creating a surface for an arbitrary segmentation of an object from a three-dimensional data set, comprising:
identifying a set of surface voxels of the segment;
for each voxel in the set:
calculating which of its neighbors are inside voxels to generate a case vector; and
using the case vector to determine the location and direction of a polygonal surface within the voxel with which to divide the voxel; and
generating all of the polygonal surfaces to create a segment surface.

2. The method of claim 1, wherein if for a given voxel the case vector is ambiguous as to where to divide a given surface voxel, further comprising post processing prior to generating the polygonal surfaces.

3. The method of claim 2, wherein said post processing includes subdivision of ambiguous voxels into smaller scale voxels, recalculation of case vectors as to each smaller scale voxel, and division of said smaller scale voxels with polygonal surfaces.

4. The method of claim 1, wherein each polygonal surface comprises triangles.

5. The method of claim 4, wherein each polygonal surface comprises either two or three triangles.

6. The method of claim 1, further comprising reducing the number of polygons in the segment surface via mesh reduction.

7. The method of claims 1, further comprising filling any holes in the segment surface to create a closed segment surface.

8. The method of claim 7, wherein the volume of the closed segment surface is calculated as a measure of the volume of the actual object represented in the data set.

9. The method of claim 1, further comprising displaying the segment surface in either solid mode or wireframe mode.

10. The method of claim 9, wherein the segment surface can be displayed either using all of the originally generated polygonal surfaces or using polygonal surfaces as reduced by mesh reduction.

11. The method of claims 1, wherein said generating a case vector includes determining which direct neighbors of the surface voxel are inside voxels.

12. The method of claim 11, wherein said generating a case vector further includes determining which edge and corner neighbors of the surface voxel are inside voxels.

13. The method of claim 12, wherein the location and direction of a polygonal surface within a voxel is a function of the case vector.

14. The method of claim 1, wherein the location and direction of a polygonal surface comprises which edges of the surface voxel the polygonal surface intersects.

15. The method of claim 14, wherein said determining the location and direction of the polygonal surface further includes interpolating to determine which point on each edge of the voxel said polygonal surface should intersect.

16. A method of creating a surface for an arbitrary segmentation of an object from a three-dimensional data set, comprising:
identifying a set of outermost inside voxels of the segment;
for each voxel in the set:
calculating which of its neighbors are outside voxels to generate a case vector; and
using the case vector to determine the location and direction of a polygonal surface within the voxel with which to divide the voxel; and
generating all of the polygonal surfaces to create a segment surface.

17. A method of generating a surface for an arbitrary segmentation of an object from a three-dimensional data set, said segmentation being based upon a threshold, comprising:
implementing the method of claim 1 if the threshold was sparing; and
implementing the method of claim 16 if the threshold was liberal.

18. A computer program product comprising a computer usable medium having computer readable program code means embodied therein, the computer readable program code means in said computer program product comprising means for causing a computer to create a surface for an arbitrary segmentation of an object from a three-dimensional data set, comprising:
identifying a set of surface voxels of the segment;
for each voxel in the set:
calculating which of its neighbors are inside voxels to generate a case vector; and
using the case vector to determine the location and direction of a polygonal surface within the voxel with which to divide the voxel; and
generating all of the polygonal surfaces to create a segment surface.

19. A program storage device readable by a machine, tangibly embodying a program of instructions executable by the machine to perform a method of creating a surface for an arbitrary segmentation of an object from a three-dimensional data set, comprising:
identifying a set of surface voxels of the segment;
for each voxel in the set:
calculating which of its neighbors are inside voxels to generate a case vector; and
using the case vector to determine the location and direction of a polygonal surface within the voxel with which to divide the voxel; and
generating all of the polygonal surfaces to create a segment surface.

20. The computer program product of claim 18, wherein said generating a case vector further includes determining which face, edge and corner neighbors of the surface voxel are inside voxels.

21. The program storage device of claim 19, wherein said generating a case vector further includes determining which face, edge and corner neighbors of the surface voxel are inside voxels.
